(19) United States
(12) Patent Application Publication
(10) Pub. No.: US 2009/0125435 A1
(43) Pub. Date: May 14, 2009

(54) Trading Plaftorm System and Method for Diamond and Precious Stone Transactions

(76) Inventors: Ehud Cohen, Tel Aviv (IL); Albert J. Angel, N. Miami Beach, FL (US); Tamar Kalcar, Klachim (IL); Abraham Stern, Brooklyn, NY (US)

Correspondence Address: ROBERT C. KAIN, JR., 750 SOUTHEAST THIRD AVENUE, SUITE 100, FT LAUDERDALE, FL, 333161153, US

(21) Appl. No.: 12/270,054

(22) Filed: Nov. 13, 2008

Related U.S. Application Data
(60) Provisional application No. 60/987,923, filed on Nov. 14, 2007.

(51) Int. Cl. G06Q 50/00; G06Q 40/00

(52) U.S. Cl. 705/37; 705/35

(57) ABSTRACT

The transaction method and system facilitates sales of diamonds or stones. A searchable database of stones includes, for each stone, an offer to sell, a weight-carat, other stone characteristics and an electronic copy of a grading lab certificate which uniquely identifies each stone from all other stones in the database. A search displays, for each stone, the offer and stone weight, stone characteristics and electronic access to the stone's certificate. The system permits a prospective buyer to “buy now,” which closes the transaction at the posted offer, or “bid now” wherein the system logs a bid value and an expiry time. Other bids are posted and displayed, in a primacy order until (a) the seller “buy now at the bid” or (b) withdraws the offer or (c) replaces the offer with a subsequent offer. Preferably, offers: displayed in time sequence and bids: displayed by primacy of price and expiry.

This is a regular patent application claiming priority from and the benefit of provisional patent application 60/987,923 filed Nov. 14, 2007, the contents thereof being incorporated herein by reference thereto. This application should be cross-referenced to Ser. No. 11/134,039 filed May 21, 2005, the contents thereof being incorporated herein by reference thereto.

The present invention relates to a trading platform, using a computer system and communications network, for trading diamonds (polished or rough) or precious stones. The trading platform facilitates sale transactions of certified polished diamonds or precious stones generally between professional sellers and buyers. Rough diamonds may be sold based upon known and accepted characteristics of those rough diamonds. Financial modules are linked to the trading platform to fiscally support immediate payment (herein “cash”) and credit trading. Authentication modules are also linked to the trading platform to assure that the electronically represented goods (diamonds) are transported and independently authenticated prior to delivery in a fully transparent and electronically documented manner.

### BACKGROUND OF THE INVENTION

Electronic or computerized trading platforms for diamonds or precious stones have been proposed but never successfully implemented. See U.S. Pat. No. 5,950,178 to Borgato.

Some diamond and precious stone merchants permit users to search diamond records stored in a computerized database but trading is limited by the use of off-system communications channels. Other prior art systems permit the user to view a diamond certificate (a grading lab certificate) for a selected diamond stone. The off-system communications channels are one-to-one electronic channels such as cell phones, telephones, instant message services, etc. between the seller and the buyer without system intervention, assistance or interaction. These prior art database systems permit the user to conduct a search through a data collection and show one or more diamond records which match the search inquiries (typically, the four “Cs,” carat weight, color, cut and clarity). Other diamond trading systems maintain as confidential the identity of the buyers and sellers and use live operator “traders” working with the database and the buyer and seller to close the transactions. However, these captured transaction platforms using a live person or broker as part of the transaction trade and do not employ a full range of buyer to seller communication services and tracking of goods through delivery nor do these prior art services employ independent authentication services.

In general, business-to-business transactions in diamonds (or in some cases precious stones) involve one of three types of transactions. Either the goods are sold “cash on delivery,” generally classified as “spot market” sales or cash sales (herein referred to as “cash” sales), or sales are made based upon a credit “memo agreement” wherein the seller transfers possession of the stone to the buyer and the buyer agrees to pay the seller the cost of the stone plus a certain additional amount to be paid at a certain time (1 month, 2 months, etc.) or the stone will be returned. The third type of transaction is a pure credit transaction which involves a third party extending credit terms (or the seller or a system operator sponsor extending credit terms) to the buyer and possession and ownership of the stone is passed to the buyer when the credit provider pays the seller. In addition, there are off market supply arrangements such as exclusive output agreements. Off market supply arrangements are generally not supported by the present transactional system.

### OBJECTS OF THE INVENTION

It is an object of the present invention to provide a trading platform system and a method to support diamond and precious stone transactions.

It is a further object of the present invention to provide a trading platform and a system and a method wherein the potential buyer can buy or bid on and simultaneously view the unique diamond or stone certification certificate, in an electronic form, prior to bidding on or buying a particular stone. The certificate uniquely identifies and distinguishes that stone from all other stones in the searchable electronic data collection.

It is a another object of the present invention to provide bidding data points or information (such as other bids) to a bidder for diamond stones and precious stones, for a uniquely identified and certified diamond or precious stone, wherein the data points assist the potential buyer in making a bid for the unique stone.

It is another object of the present invention to provide a diamond and precious stone trading platform with finding transparency.

### SUMMARY OF THE INVENTION

The computerized method and system facilitates the sale and purchase of precious stones (emeralds, rubies, etc.) or polished or rough diamond stones (herein, all stones are collectively generally identified as “diamonds”) and is deployed over a computer network and a communications network. The method and system utilizes a data collection of diamonds or stones, which data collection (database) includes the stone weight (carat) and at least one other stone characteristic. Preferably, the data collection, typically a database, includes many stone characteristics such as cut, clarity, color and other established, recognized stone characteristics. Further, the transaction system utilizes an electronic copy of a grading lab certificate which uniquely identifies each stone from all other stones in the data collection. Sellers upload stone or diamond record information to the data collection. These records list stones offered for sale in addition to the unique grading certificates. The transaction system and method permits searching of the data collection and, based upon the search results, generates an output display of data including stone weight and stone characteristics and also provides electronic access to the stone's unique grading lab certificate. Additionally, offer to sell data is listed in the search result display. The system permits a prospective buyer to buy the stone at the stated offer to sell price (a “buy now” functional display) or place a bid on the stone (a “bid now” function). Preferably, the bid to buy data includes a bid price and an expiration time or expiry data, after which time the bid is no longer valid. The bid is a legally binding bid such that if the seller accepts the posted bid, the buyer is committed to the purchase of the stone at the posted bid price. Other bids for stones are acquired by the system until the offer to sell is withdrawn by the seller or is subject to a sale indicated by a sold stone event. In a comprehensive system, the bids are displayed to the prospective buyer in an organized format using primacy factors such as the total bid price and expiry data. Transaction charges are added to the offers to sell and these transaction charges are also displayed.

### BRIEF DESCRIPTION OF THE DRAWINGS

Further objects and advantages of the present invention can be found in the detailed description of the system embodiments when taken in conjunction with the accompanying drawings in which:

FIGS. 1A and 1B diagrammatically illustrate the trading platform, method and software program functional modules for the transaction system;

FIGS. 2A-2B show input and output display screen formats employed for the transaction system (other input or output formats may be used) and show data field elements from the data collection of stones;

FIG. 3 diagrammatically illustrates a financial process diagram showing various purchasing systems including a cash transaction system, a memo transaction system and a pure credit transaction;

FIG. 4 diagrammatically illustrates one type of diamond record (other diamond or stone records may be used);

FIG. 5 diagrammatically illustrates graphic modules for seller's and buyer's transaction modules and the relationships therebetween;

FIG. 6 diagrammatically illustrates authentication routines and the transparent process for the trading system;

FIG. 7 diagrammatically shows the relationship between quantity-price of the transaction as compared with disclosure requirement and risk assessment issues for the transaction; and,

FIGS. 8A and 8B diagrammatically illustrate a general system diagram.

### SYSTEM AND METHOD DETAILS

The present system and method relates to a trading platform, using a computer system and communications network, for trading diamonds (polished or rough) or precious stones. The trading platform facilitates sales transactions of certified polished diamonds or rough diamonds or precious stones. Bid and buy software modules, financial modules and delivery-authentication modules are linked to the trading platform to support immediate payment (herein “cash”) trading. Certain features and modules are described herein as operable with some aspects of the system. It should be noted that these modules can be re-configured to work with other aspects or functions of the system. The method steps and functions may be reorganized in different sequences to improve system efficiency.

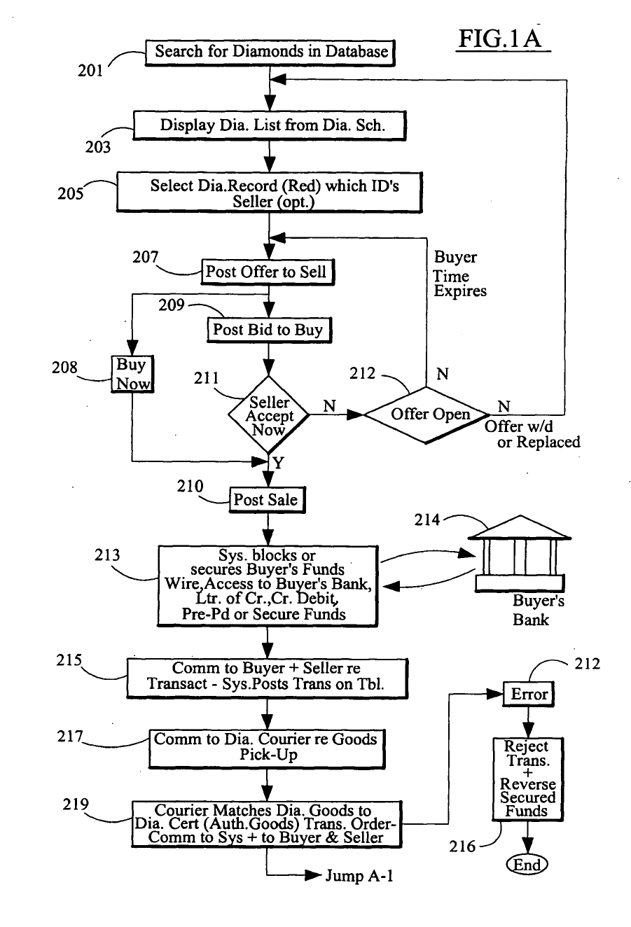

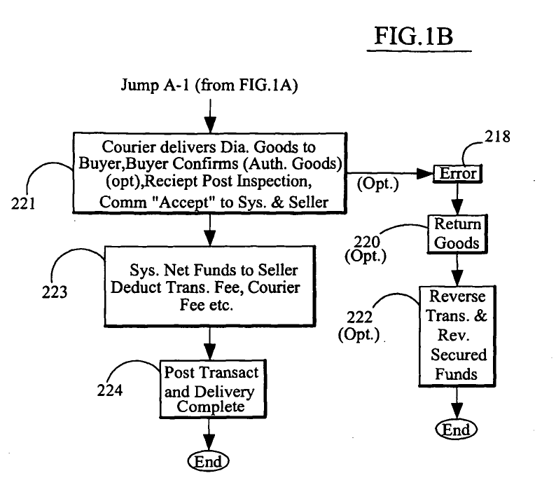

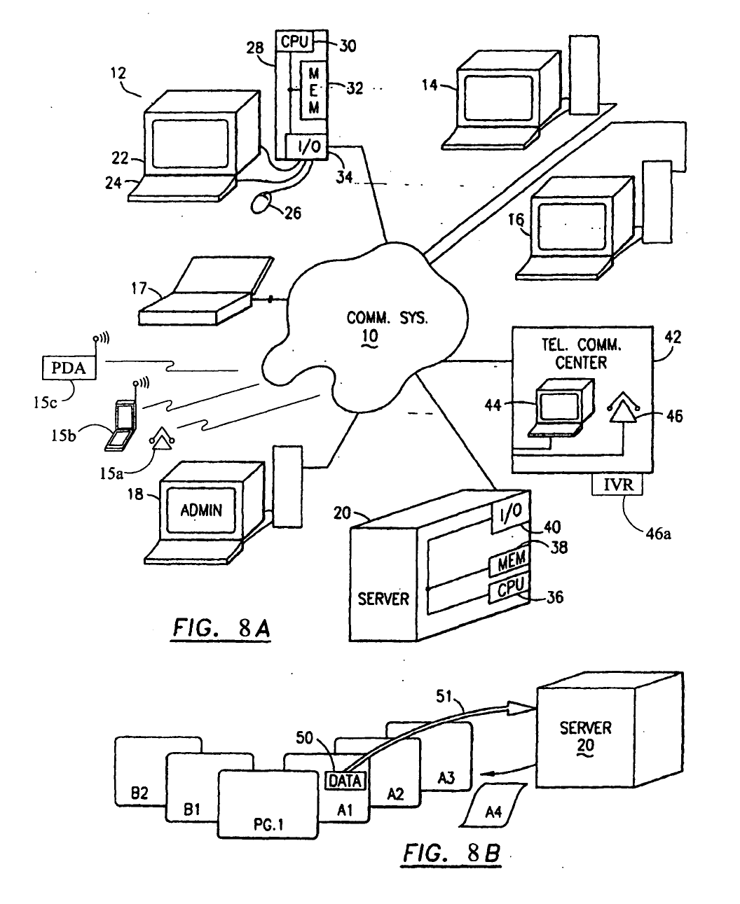

FIGS. 1A and 1B diagrammatically illustrate the basic transactional method and system for buying and selling diamonds or precious stones which stones are subject to classification and certification and verification. Further, FIGS. 1A and 1B show the transparent funding and delivery method and system. Step 201 involves the search for diamonds in a database. The search uses a search engine operable on the diamond and precious stone data collection, typically a database. Step 203 displays a search output result as a list of diamonds or stones (“Dia. list”) from the “Dia.Sch.” or diamond search. This diamond search function is shown generally in patent application Ser. No. 11/134,039, filed May 21, 2005, Publication No. US-2006-0265310-A1, published Nov. 23, 2006 which is incorporated herein by reference thereto. The computerized system and methods herein may be configured as software or hardware modules as discussed later herein. Some abbreviations, for system or process functions or elements are listed in the Abbreviations Table discussed later in connection with FIG. 8A. In step 205, the buyer selects a diamond record (rcd) which usually identifies the seller with seller contact data. Another system may omit the seller id data such that the seller and the buyer may remain anonymous. In step 207, the system posts an offer to sell a diamond or stone form the seller. In practice, the seller typically sells a large quantity of stones and the “post offer to sell” task involves uploading a plurality of stones offered for sale. Further, the inventory uploaded for sale may change the offer price for previously listed stones. The seller posts offers either by unloading the diamond record into the data collection, or otherwise modifying the data collection. This is an input, “offer to sell” data event (a sale price), for a particular diamond. In most cases, the diamond is further specifically uniquely described and graphically illustrated by a unique pictograph by a grading lab and the diamond is identified by a certificate issued by the lab. A photograph or pictogram often is part of the grading lab certificate which shows the location, degree, shape and size of flaws in the diamond stone. One lab certification by a trusted third-party is a GIA (Gemological Institute of America) certificate. Each diamond is uniquely identified by a correspondingly unique grading lab certificate. The diamond DIA record includes an offer to sell. Step 209 contemplates a “bid now” or bid input data event from the buyer. This “bid now” event is a posting of a bid 209 to buy a certain stone associated with a certain diamond or stone certificate at a certain price. Alternatively, the user may select “buy now” function 208 after the seller's offer to sell posting 207 rather than a “bid now” step 209. The buyer may “bid now” or “buy now” a specifically identified stone, or parcel of stones, or pair of stones, or set of stones in steps 209, 207. A Parcel of stones, a pair of matching stones, or a set of matching stones are discussed later. The bid now to buy data at input 209 normally includes an expiration time or bid validity period (expiry data) after which the bid is automatically withdrawn or cancelled by the transaction system.

Step 211 is a decision by seller or vendor to “accept the bid” or a seller's “buy-at-the-posted-bid” function. Step 211 determines whether the bid is accepted by the buyer. In a current embodiment of the system and method, the buyer's posted bid is legally binding in that, if the seller accepts the posed bid in step 211, the sale is complete or “closed” and the financial transaction modules described below are activated. The seller activates an “accept bid” module 211. In a sense, the bid acceptance at 211 is the same as posting an offer to purchase publicly traded securities at a certain price and in a certain quantity. The computerized transaction system then closes the sale transaction. If NO, the system in step 212 determines whether the “offer to sell” remains open, and whether bid has expired (bid expiry data) or whether the offer to sell has been withdrawn or replaced by the seller. “Replacement” includes the concept that offer to sell price data is reduced (or increased) to a new “sell” price. A withdrawal (w/d) or replacement returns the system to a pre-search and display function step 203.

If the “buy” function is activated in steps 208 (buy now—buyer step) or 211 (accept now—seller step), the system in step 210 posts the “SOLD” event (“post sale”) in the system as a data point in the data compilation. As used herein, the term “diamond” represents both a single diamond sale, subject to a single certification certificate, as well as parcels of diamonds which are graded in groups and into certain classes as adopted by the c-c-c-c categorization (carat, cut, clarity and color). The c-c-c-c classification is well known for polished diamonds. Other classification systems are known for rough diamonds. Precious stones have different grading or classification systems. These further classification systems fall within the scope of the claims herein. If a “buy” event between the buyer and seller has not occurred or if the “accept bid” step 211 has not been activated by the seller within the expiration time, step 212 ultimately involves (a) replacement or withdrawal of the offer to sell or (b) expiration of the bid to buy. In one embodiment, the seller's identity is known to all bidders, and the seller can view the identity of all bidders on a certain stone in the seller's inventory, but each bidder on a certain stone is anonymous to all other bidders on that certain graded stone. If no sale is noted per steps 208, 211, the system loops to a point prior to step 203 which involves a display of a diamond list resulting from user's diamond search. If no sale is noted at 208, 211, the offer and bid cycle continues between a particular buyer and seller for a particular diamond. Sellers may increase or decrease the offer to sell a certain stone. Buyers may increase or decrease or change the expiry date on a bid to buy a certain stone.

In the current embodiment, the seller's identity is available to all bidders (prospective buyers), and all bidders are known to the seller, but each bidder is blind to all other bidders (the prospective buyers are substantially anonymous). Seller and buyer data is mutually viewable when the funds are secured and delivery data is posted to the parties in the sold stone transaction.

If a “buy” has occurred, the system, in step 213, blocks or secures buyer's funds. Preferably, finds are secured for transfer by the transactional system or trading floor by electronically sending an “ACH” bank memo to the buyer's bank and the buyer's bank transferring money to the system operator's designated bank. A designated system operator account is currently utilized. This electronic event is recorded as a “sold stone event” by the transactional system (the bank electronically notifies the system operator) and the sold stone record is made available to the buyer and seller. Alternately, these funds may be placed in an escrow account in the system operator's bank. Other payment processes include (a) pre-payment (“Pre-Pd”) of a sum by the prospective buyer into the system operator's account (held until the sold stone event); (b) the buyer sending a bank wire to transfer funds from the buyer's bank 214 to the system operator's bank (a confirmation then sent to the system trading platform); or (c) a transfer from the buyer's bank to the system operator's bank (discussed later); or (d) permission (authorization) from the buyer that the system operator (or its designated bank) directly access the buyer's bank (an ACH—electronic clearinghouse transaction) and secure those funds in the system operator's bank; or (e) placement of funds into an escrow account. The buyer may have a letter of credit previously established between the buyer and the system operator (or its financial institution), or the buyer may use a credit card, a debit card, or other type of financing which enables the system operator to freeze or secure (legally lien) the buyer's funds for the sale price of the diamond. Step 215 involves a communication to the buyer and the seller that a buy transaction or sold stone event has occurred and the buyer's funds have been frozen, secured or transferred to the system operator for the diamond or sold stone transaction.

In some cash transactional systems, the buyer and seller may be anonymous to each other but the system operator knows the identity of the parties. The system logs the sold stone event or transaction in the DIA record and a Cash Market Transaction Table. The Cash Market Table is a display made available to members of the trading platform or floor. The Cash Market Table is a compilation of data, grouped per pre-determined classifications ranges or grades (see c-c-c-c ranges) and the Table is displayed, in real time, to members of the trading platform. The Cash Market Table is simply a display which shows the current spot transaction for this cash sale of a diamond that is a commodity having certain classifications and ratings. A reporting module displays the spot market trades, typically by grouping the sold diamonds into known, classified groups (ranges of carat weight), cut, clarity, color, etc. Rough diamonds or other precious stones have different classification systems.

Step 217 communicates to a trusted diamond courier that the goods are ready for pick-up. This communication includes several data points or pieces of information including the seller's pick-up address (where the goods are to be picked-up), the diamond record (discussed below) as well as electronic access to certification papers for the diamond and other data such as the location of the delivery site. Secondary communications to the buyer and seller are programmably available. Step 219 involves the courier obtaining the goods at the pick-up location (pick-up acknowledgment communication to the system generally required by the courier) and having an independent third party inspector match the diamond or precious stone to the diamond certificate, that is, a direct authentication of the goods by physically comparing the diamond to its unique certificate (inspection acknowledgment communication to the system required). The courier may use cell phone 15b, land telephone line 15a or personal data assistant (pda) 15c in FIG. 8A. Computer log in with laptop 17 is also an available communications log-in. On line access to the DIA grading certificate is part of the system. The courier and the third party certification authority confirms that the goods subject to transport physically match the transaction order and stone certificate by communicating the authentication with the system. This “confirm authentic” communication is made available to the buyer and seller. Management communications may also be initiated. A communication event to the system by the courier at pick-up, and at the interim inspection-certification check point, at the pick-up from inspection, and at final delivery to the designated buyer's site and further system communications to the buyer and seller of these transport and authentication events is processed by the system. Interim transport communications events (post-inspection but pre-final delivery) may be required by the system and imposed upon the courier.

If the goods do not match the certification or if the goods are not present at the pick-up location, an error 212 occurs. In step 216, the courier communicates with the system and the system rejects the transaction with an appropriate communication to the parties and the system operator reverses the secured funds. The system then jumps from jump point A-1 in FIG. 1A to FIG. 1B.

Step 221 involves the courier delivering the diamond or precious stones goods to the buyer and an optional buyer confirmation that the goods match the diamond certificate. This optional “buyer authentication” is not necessary because once the independent authentication service approves the goods at or near the time of pick-up, the buyer, in one embodiment, cannot reject the goods. The “optional buyer certification” is not important because the initial third party certification is binding upon seller and buyer. Different system configurations may include a second authentication at or near delivery. The grading lab certificate is used by the third party grading authority at or near pick-up to confirm that the stone in transit is the sold stone. Upon delivery to the buyer, a receipt is electronically or otherwise generated by the courier and sent to the system. Any optional buyer inspection and acceptance is also communicated to the system. The system subsequently sends to the buyer and the seller a communication indicating acceptance of the goods by the buyer. In some rare situations, if the goods are not accepted by the buyer (an optional system step), an error 218 occurs and the goods are returned in optional step 220 and in step 222, the system operator reverses the transaction and reverses the secured funds previously either transferred to the system by the buyer or otherwise secured for sale by the buyer in step 213. If the system has posted the cash transaction is step 215 in the Market Table, the system removes that transaction from the Table.

If delivery has occurred in step 221, in step 223, the system releases the funds to the seller (after deduction of transaction costs) and communicates the release of the funds to both the seller and the buyer. The system operator deducts transaction costs from the funds prior to delivery of those funds to the seller such as a transaction fee, a courier fee, and other miscellaneous charges associated with the delivery and/or financing of the diamond from the seller to the buyer. Step 224 posts the sale as a completed sale.

Communications to the buyer and seller are typically via email but other processes may be employed such as text message to a cell phone, interactive voice response and message services (IVR), and direct computer or web-based access to the sold stone event record. These communications track the whereabouts of the diamond subject to the transaction and the bank charges and funds transferred relative thereto. Communication events, from the courier and the independent authentication service and the subsequent transport by courier from the service to the buyer's “ship to” location, can be by email or voice mail or a web-based confirmation from these trusted transport and inspection services. Multiple confirm steps during transport and inspection are important.

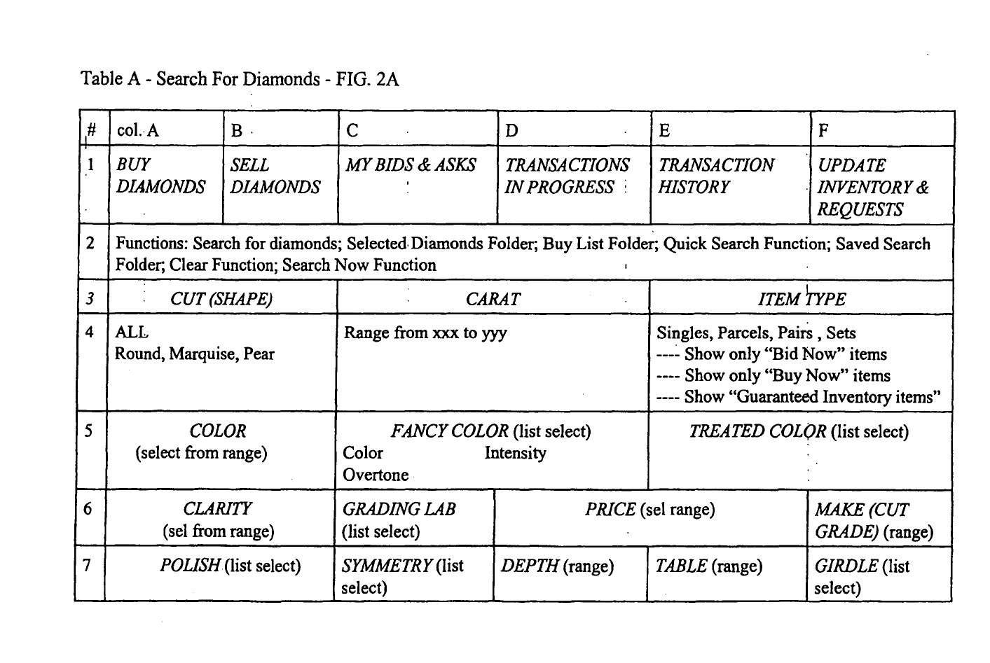

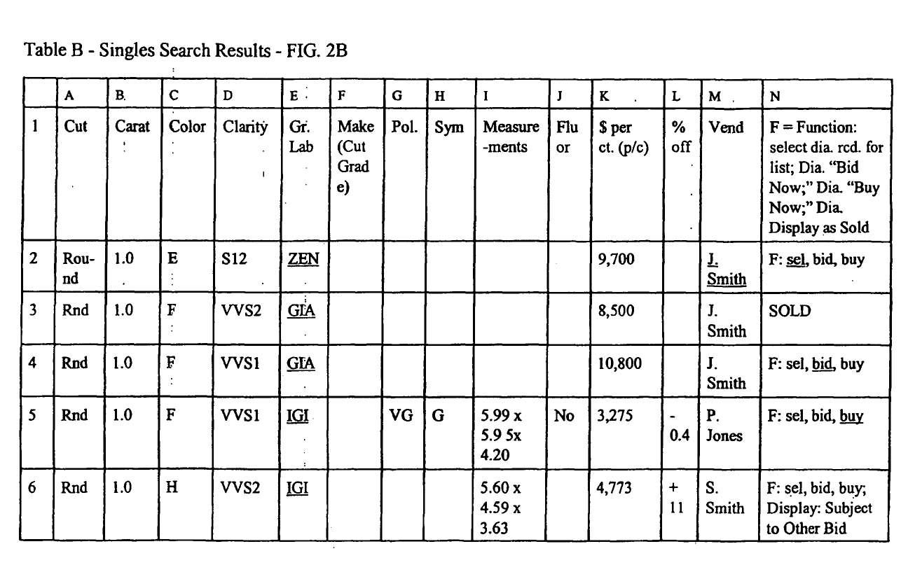

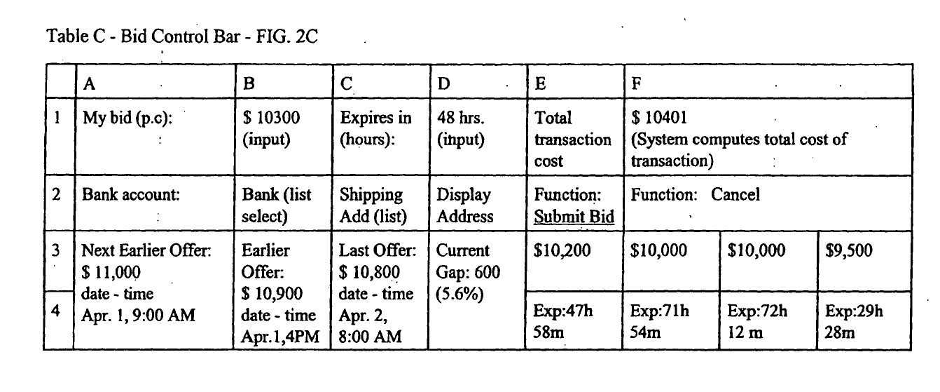

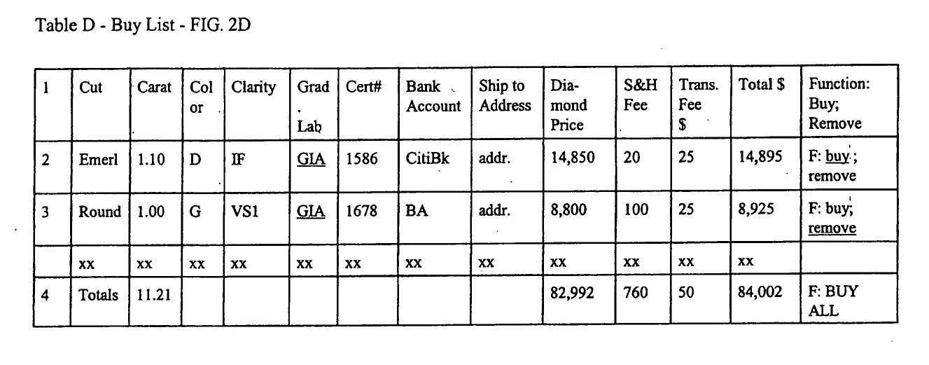

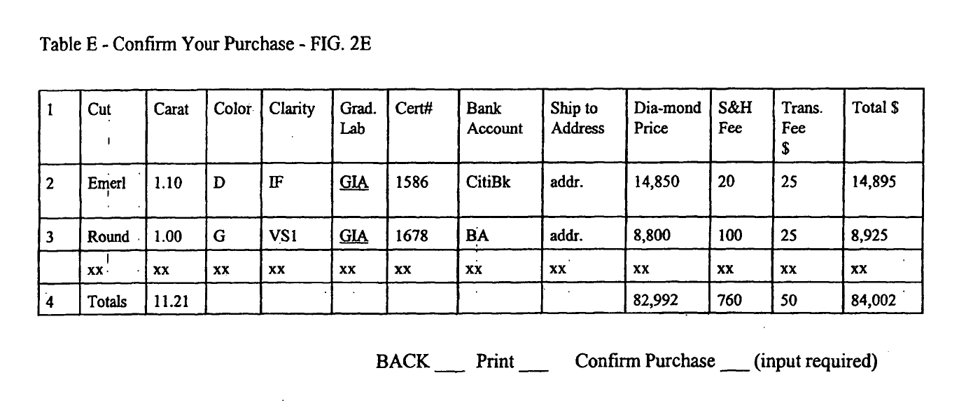

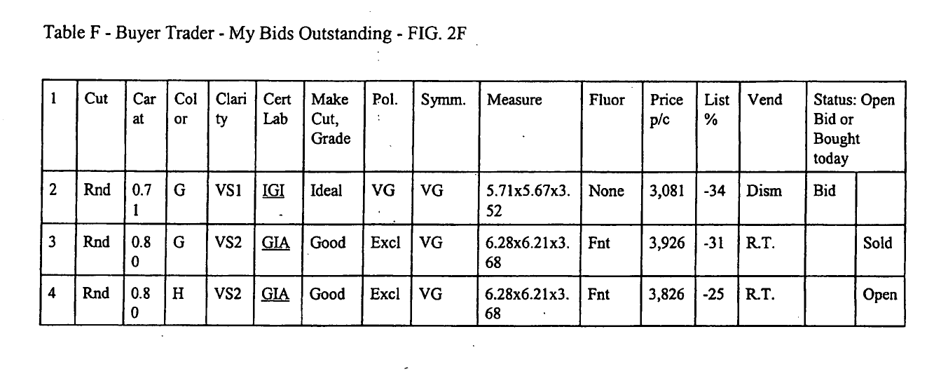

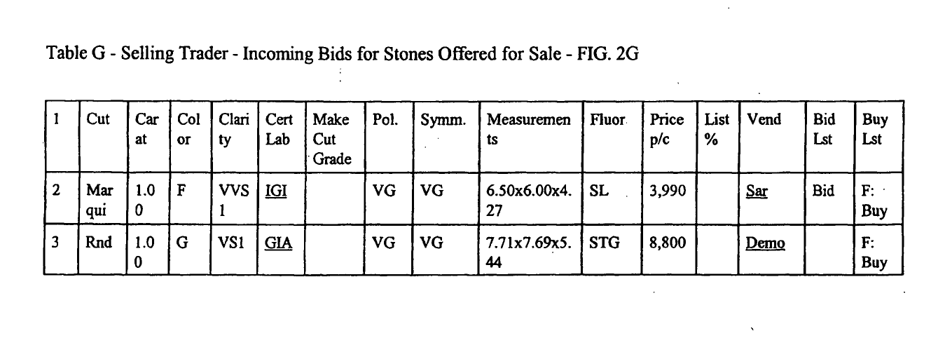

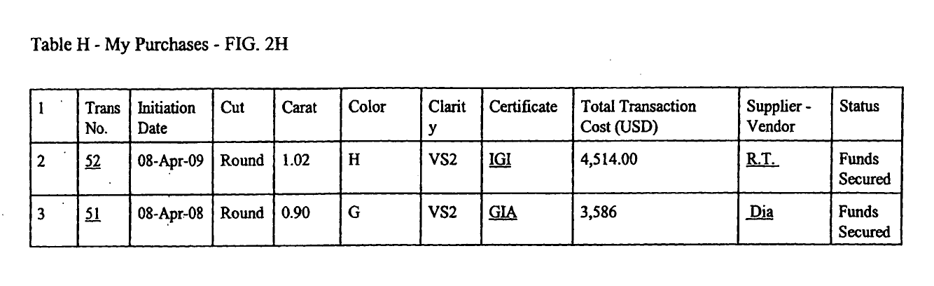

FIGS. 2A-2H diagrammatically illustrate display formats and display data generated by the transaction system. The system's processes are generally outlined above in FIGS. 1A-1B. Other display screen formats or display outputs may be employed to carry out the functional aspects and purposes of the trading platform discussed herein. The server in the system has display generator modules which format data from the data collection and present the data to an inquiring party. The column and row designators A-xx and 1-xx are shown in the Figures in order to pin point matrix segments in the display. These column and row designators (see FIG. 2A, Table A, columns A-F and rows 1-7) are not present in the display of the system nor employed in the method described herein. The A-xx and 1-xx designators are used in an effort to better explain the system operations herein.

FIG. 2A-Table A represents a display permitting a user to select various inputs and formulate inquiries for a search for diamonds. Although the term “diamonds” is used extensively herein, the present transaction system may be employed for the selling and purchase of precious stones. Rough diamond stones may also be sold using different stone grading characteristics. For illustration and ease of discussion, the term “diamonds” include precious stones. Tables A-H have numbers on the left hand column designating rows and some tables have alphabetically identified columns along the top horizontal row. Therefore, Table A, column e, row 1 is referred to herein as “E-1” and this “Transaction History” display grid coordinate refers to user-selectable tab or button or functional display area (a hot link) to another web page. Selection of a functional display causes an action from the system server which returns a further display screen to the user. This displays transactions by that inquiring party or user. Rows and columns in the Tables A-H are referred to first by a column designator and then a row designator, for example, matrix E-1 is the Transaction History functional display. The present system is an Internet based computer system employing a server computer which displays and interacts with client computers. These client computers are operated are by sellers and prospective buyers. Couriers and authenticators may also use computer network devices such as client computers. Enabled cell phones and PDAs are also network devices if operable with the system server. Intermediate communication and computer systems may interface with different network devices.

Table A, Search for Diamonds, shows that the user (a seller or vender or an inquiring buyer), can select the additional web based data, “Buy Diamonds” (A-1), “Sell Diamonds” (B-1), can select further web based data for “My Bids and Asks” which refers to, at C-1, the user's posted bids and the user's posted offers to sell or “asks”, “Transactions in Progress” (D-1), “Transaction History” showing closed or completed transaction (E-1) and “Update Inventory and Requests” to purchase stones at F-1.

In row 2, functions (“F” or “fnc”) are listed permitting the user to “search for diamonds;” or function F: “view selected diamonds,” or to enable the user to page through his or her “buy list folder” or conduct a “quick search” function on the search parameters shown on the diamond page, or request a web page data having the user's “saved search results.” The user can also select a “clear” function which resets all the inputs for the search parameters or inquiry. The user can select a “search now” function which is a functional display element (on the then-displayed output screen) instructing the server to conduct a search through the data collection of diamond and precious records based upon the search inquiry input by the user at columns A-F and rows 3-7. Rough diamond stones may also be sold using different stone grading characteristics. The Tables A-F are examples of display, classification, search and bid or buy and display formats.

The user can select the cut and shape of the stone at A-3, A-4 as round, marquis, pairs, emerald etc. Other shapes are known in the diamond trading industry. At C-3 and C-4, the user selects a stone weight typically in carats. The user may select a range or single carat weight. At E-3, E-4, the user can select whether to do a search for a single diamond, parcels of diamonds, pairs of matching diamonds, or sets of matching diamonds. The claims appended hereto refer to “diamond stones” which also refers to polished or rough diamonds or a single, identified diamond, or a parcel of diamonds (a plurality of single diamonds with multiple grading certificates), a plurality matching pairs of single polished diamonds, and a plurality of matching sets of polished diamonds. Persons in the diamond trade understand that these categories, singles, pairs, parcels, matching pairs, and matching sets, are well known. Further, these skilled diamond traders understand the parameters and ranges for these various “types” of diamond transactions. In addition under “Item Type,” E-4, the user can select a display of only “bid now items” which limits the search results to ONLY stones which are subject only to open bids or are available for bid. The user can select a display of only “buy now” items (E-4) which limits the search results to stones which can be immediately purchased from a guaranteed seller's inventory. A “guaranteed inventory” item refers to a vendor or seller status marker or indicia in the DIA record and data collection. The guaranteed inventory stone is immediately available for purchase and delivery.

The other diamond stone characteristics of color, fancy color, color grade may be selected from a range or may be selected from a pull down list. The term “select (sel) from a range” permits the user to input a single number or a range of numbers (within predetermined system limits). The term “list select” means that the user is presented with a pull down list. Clarity is selected or set by the inquiring person as a range. The Grading Lab at C-6 is a selection from a list. The selection from a list may include a “no grading lab” entry and an “all lab” entry. Price at D-6 can be a single number or a set range, typically noted as price per carat or “p. c.” The other diamond stone characteristics of cut grade, polish, symmetry, depth, table and girdle are well known to diamond traders. Step 201 in FIG. 1A employs, in one embodiment, the search for diamonds per the display input Table A shown in FIG. 2A.

FIG. 2B, Table B, is a “Singles Search Results” from a inquiry in Step 201 (FIG. 1A) and a completed search request from search parameters at Table A. System step 203 shows the diamond search result in Table B format. Common stone characteristics are listed in row 1 such as cut, carat, color, clarity as well as functional access to grading lab certificate (E-1). At N-1, function “F” lists available functional abbreviations used in column N, such as a function which permits the user to “select a diamond record” and place that diamond record in his or her preferred or selected list (a wish list or shopping cart), or permits the user to “bid now” or “buy now.” Also, in column N, the system indicates when a particular unique diamond stone has been SOLD (a sold stone event). This unique diamond stone at row 3 has been sold as indicated in Table B and by a sold stone event annotation in the data collection. The marked “sold” DIA record is not available for bid or buy operations. Column A shows “cut” of the diamond as round or “rnd.” Column E shows a functional display access to various grading labs, including GIA certificates, as hot links or a display functional elements. The user can view the grading lab certificates (column E) by selecting the hot link thereat and viewing the certificate for the particularly listed stone in the display row. As known by diamond traders, these certificates uniquely identify one stone from all other stones in the diamond data collection and generally throughout the world. Column L shows the percentage differential of the price per carat (p.c. shown in column K) as compared with other standard diamond pricing metrics. One diamond pricing metric is published in the Rapaport Diamond Report and another diamond price metric is provided by IdexOnline. At row 2, the user has selected the diamond record to be placed in his or her “selected diamond folder.” See, Table A, row 2. The diamond at row 3 has been sold and is not available for bid or buy. The diamond at row 4 is available for bid and, if the user selects the “bid” command functional display, the user will activate a bid command module on the server which is discussed later. At row 5, the user has selected a “buy” function (N-5) and has activated the buy command functional display. By activating the buy command functional display, the server initiates the buy command module which is discussed later. The buy command functional display (N-5) is mutually exclusive, in a command or selection sense, as compared with the bid command functional display (N-4). At N-6, the user can select functions “select for my list,” “bid now,” or “buy now,” however the area N-6 indicates that other persons have placed a bid on the stone identified by that unique grading certificate at E-6. Area N-6 may be highlighted or flashing or otherwise marked to show other pending bids. Therefore, the system displays an unique marker to the user in the “Display Search Results” Table 2B which notifies the user that others have placed an active, non-expired bid on that particular stone. The user can look at the stone's grading certificate with a single click-on action and see the quality of the stone whose characteristics are summarized in the “Search Results” Table B. As stated earlier, any inquiring buyer or seller after selecting a particular stone can click on or activate the functional display at E-6 and view an electronic version of the grading certificate for the stone at row 6. This electronic access point for buyers and sellers and trusted third party inspectors is one of several important aspects of the present system.

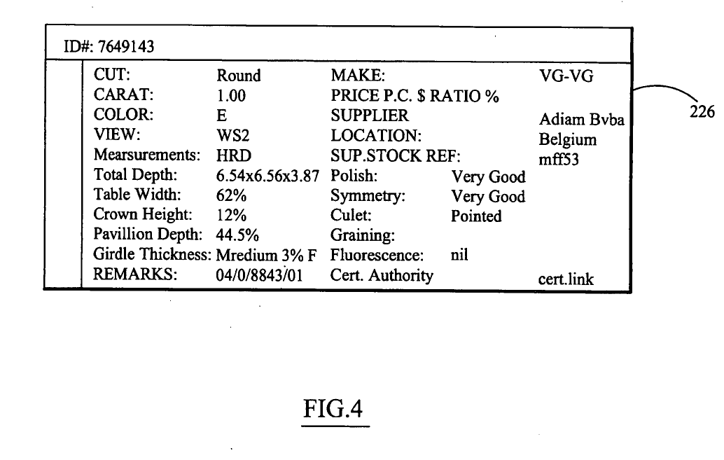

As explained earlier, the seller or vendor uploads a plurality of diamond records available for sale, each diamond record having offer to sell data as part of the record. See FIG. 4, “price P.C. $” referring to a price per carat for the diamond at diamond record 7649143. FIG. 1A herein does not discuss the process of uploading and organizing these diamond records. However, patent application Ser. No. 11/134,039, does describe such an upload system. Step 207 in FIG. 1A encompasses these uploads by vendors of diamonds.

If the user from Table B selects the bid command functional display (N-4), Table C is displayed as part of the bid command module executed by the server in the computer system. Preferably, the bid command module is shown next to (above or below) the diamond record potentially subject to the bid. Rather than an overlaid display, other user friendly “bid now” displays may be employed. In general, row 1 in Table C represents an instructional display and a request for input data, see “my bid” at A-1. The user inputs bid data at B-1 as noted by “(input)” data 10,300 at B-1. In one process, the user is expected to input expiry data or expiration time (C-1). In the illustrated Table C, the user has input 48 hours (D-1). The system computes and displays a total transaction cost (E-1) as 10,401 (F-1) which amount is computed by the system to include shipping, handling, taxes, courier charges, transaction fees, and all other charges over and above the total price and the price per carat input at B-1. Row 2 includes some data about the buyer's bank, shipping address (columns A-D, row 2) as well as functional displays at E-1 permitting the user to “submit the listed bid” or the function at F-2 to “cancel” the screen data previously input by the user.

At rows 3, 4, offer data is shown in a primacy format and bid data is shown also in primacy format. In other words, the last offer to sell data (C-3) is the current offer to sell price for the specifically listed diamond (Table B, row 4) which is 10,800. The last offer to sell is the only legally binding offer posted by the seller. The other “offer data” (to the left of C-3) is presented for historical purposes but does not represent a true, legal offer to sell the unique stone at the displayed price. This last offer C-3 was made April 2 at 8:00 AM. Offer entry date and times show the seller's interest in selling this particular stone. The offers may increase, rather than decrease (Table C shows a decrease). The time indicates inventory status. Several bids are shown at E-3 and F-3. All bids, in the current embodiment, are legally binding bids to buy for the unique stone associated with the grading certificate viewable by all participants. These bids are posted and progress from the highest bid to the lowest, in order of price primacy, 10,200; 10,100; 10,000; and 9,500. Therefore, the order of primacy of bids is from the highest or best bid price (or value) to the lowest. Secondarily, the bid primacy is the near term bid validity time. As noted above at D-1, the user should input an expiration or expiry time which indicates the time the bid is valid. Without an input, the system may apply a default time. The data at E and F, row 4, shows that the highest bid to buy the stone expires in 47 hours, 58 minutes, and the two bids at 10,000 first expire at 71 hours, 54 minutes and at 72 hours, 12 minutes. Therefore, the 10,000 bid expiry in 71 hours, 54 minutes has a higher priority or primacy compared with the bid 10,000 expiry 72 hours, 12 minutes. The “next to expire” bid has a higher primacy which is referred to here as the near term bid validity time. The second level primacy order of offers is the offer posting time. The first level primacy order is the bid value. The primary order for offers to sel is the near term offer.

The current gap or differential between the last offer and the highest bid (D-3) stands at $600.00 per carat (P.C.) which is 5.6% of the offer value. The offer to sell data from the last offer 10,800 and the next earlier offer to sell data 10,900 and the previous offer 11,000 is shown at columns A, B and C, rows 3, 4. The dates these offers are posted are also included. Therefore, a person viewing bid control bar can understand the current interest on that particular uniquely identified stone (Table B, row 4 stone) indicated by unique, one-of-a-kind grading lab certificate at E-4 (Table B), and also understand that the vendor has reduced the price from 11,000 to 10,800 over the past 24 hours. Table C, A-4, B-4, C-4.

A “buy now” control bar (not shown) may be used to permit the buyer to select his or her bank, shipping address and confirm the total transaction price. The buy now control bar may be similar to Table C. Alternatively, the buy now functional display may directly electronically close the transaction and initiate a sold stone event. Other payment plans or options may be shown and selected by the bidding prospective buyer.

Table D shows the user's Buy List at FIG. 2D. The display areas in row 1 are fairly common including grading lab, certificate number, the bank account selected by the buyer associated with that particular stone for sale, the shipping address, the total diamond price, shipping and handling fee (S&H fee) the transaction fee, the total cost of that purchase. The user, in the far right column, may select various functions (“F:”) which are functional display elements on the display output screen (the screen output by the server and displayed on the user's client computer). The user can buy the diamond by selecting “buy” or remove the diamond from the buy list with the “remove” function. Row 4 shows transaction totals. Other “buy now” functions may be used.

Table E, Confirm Your Purchase, is shown in FIG. 2E. Table E is a double check or a “confirmation of buy” list from the Table D list. A double confirmation of a “buy order” for goods or services is common on Internet and in web enabled transaction systems. The user, as shown below Table E, can go “back” to a previous web enabled page, “print” the current “confirm purchase” page, and can select the functional display element “confirm purchase.” The user must select “confirm purchase” to close this transaction for the selected diamonds. The “double confirm buy” function may be omitted for the “buy now” function at step 208, FIG. 1A and N-5, Table B, FIG. 2B. A “buy now” may be set to close the entire diamond transaction as a sold stone event.

Table F is a “Buyer Trader—My Outstanding Bids” table for the buyer. Most of the columns at row 1 are self explanatory. The list percentage (list %) column is the ratio of the price per carat versus a stated diamond metric or standard price. The vendor column (“vend”) to the right of “list percent” shows the name of the seller or vendor. The “status” column on the far right shows whether the bid is “open” (not closed or subject to a sold stone event) or whether the user has bought the item today or whether it's “Bid” is still operational on the selected diamond.

Table G in FIG. 2G shows a “Selling Trader—Incoming Bids for Stones Offered for Sale” table. The column labels in row 1 are fairly self explanatory. The “Vendor” column indicates that several different subsidiaries or persons, representing the vendor, are selling stones. The “bid list” shows whether any bids are active on those specific diamonds. The “buy list” enables the seller to “buy now” or accept the best or highest offer by selecting the buy button as a functional display element on the screen. The buyer, selecting the buy button in Table G, reduces the offer to sell price to the posted best bid to buy price as per the primacy factors discussed earlier. Again, the seller can select the grading certificate lab and electronically access a copy of the certificate and see the diamond certificate associated with a particular diamond. This electronic access assists in the decision to sell at the best offer price. In a preferred embodiment, Table G, the “Seller Trader—Incoming Bids” table, includes a “buy” or an “accept bid” display function or button which close the entire diamond transaction as a sold stone event.

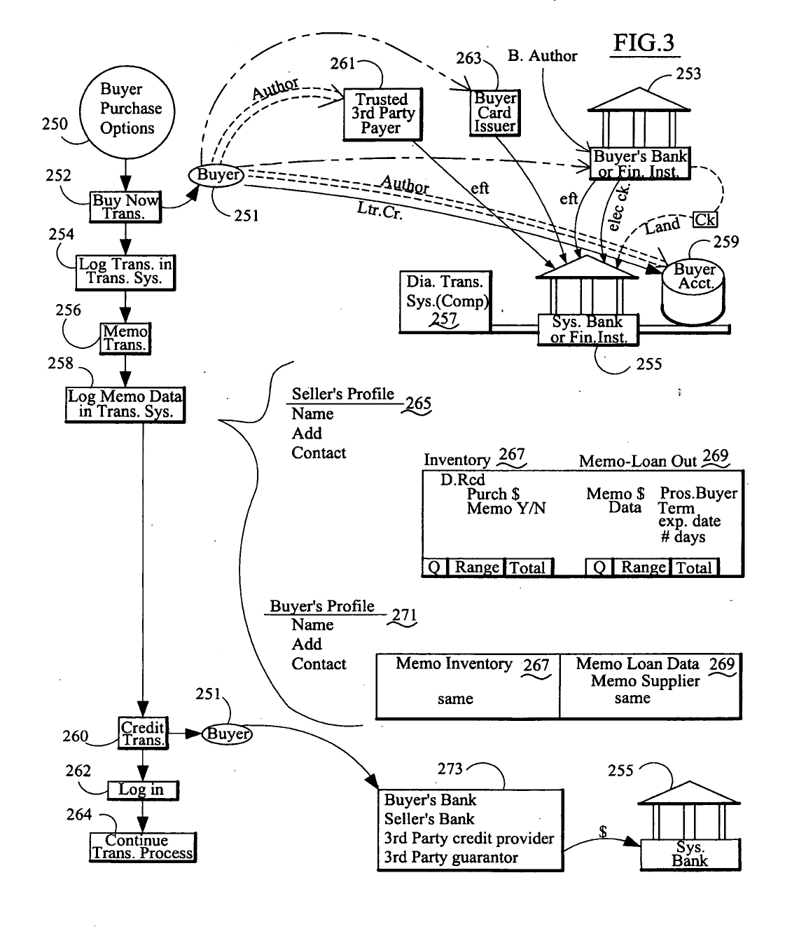

Table H, “My Purchases”, is shown in FIG. 2H. Purchases relate to buyers' records. Sellers or vendors may have the same general display output from the diamond transaction service but the sellers table would be called “Sales Made.” The “transaction number” on the left hand column is a tracking number assigned to that sale by the system. “Initiation date” is the date the “buy now” button has been selected by the buyer. The buyer can also view the electronic certificate for the particular stone. This on-line view facilitates re-sale of the stone by the buyer. The supplier's name and contact data is accessible. The far right hand column shows whether the funds have been secured or have been transferred. This is discussed later in conjunction with FIG. 3.

As shown and discussed in connection with the foregoing figures, the system permits an inquiring party to search a data collection of precious stones or diamonds and the web-based server system returns display data with stone weight data and at least some additional stone characteristic data and concurrently provides electronic access to the stone's unique lab certificate which identifies and distinguishes the stone under consideration from all the stones in the data collection. The user can select a buy command functional display or a bid command functional display (Table B). The “buy now” function immediately places the selected unique stone in a buy list and the buyer's preferred bank is listed thereat. The buyer can change the bank with the drop down display list. Further, the “buy now” button selects the deliver or ship to address as the preferred address in the buyer profile or contact data. That data can also be changed by a list selection. Alternatively, the “buy now” button function can be simplified to default to a seller's preferred bank and delivery destination. In a truncated “buy now” function, the transaction closes almost instantaneously with the functional selection of “buy now.” System processing times to close the sale are nominal. Ultimately upon activation of the buy command, a sold stone event is noted in connection with the particular unique diamond (Table B, N-3) and no further bids are permissible or accepted from other inquiring prospective buyers. The buy command is mutually exclusive compared to the bid command.

Alternatively, if prospective buyers bid on the diamond, other prospective buyers first note that an open bid has been placed on the diamond Table A, N-5, and then can view other posted bids, in primacy order, on the diamond. Bidding buyer data is blind to the bidding pool but is open to the seller.

With respect to the expiration or expiry data for particular bid to buy, rather than have the user input expiry data, the system may compute expiry data based upon some standard of time (for example, all bids expire in 5 hours, or in 24 hours, or in 48 hours) or based upon the value of the diamond sought to be purchased, or some other algorithm.

On the transport side of the trading platform, electronic access to the purchased stone's unique lab certificate is made available to the independent authentication service and also to the diamond courier. These individuals or companies can obtain access to the unique lab certificate via the computer network discussed below in connection with FIG. 8A and a computer network device (computer, personal data assistant, configured cell phone, etc.) to assist in the independent confirmation of the diamond and the transaction record. This transparency during transport is one of several important features of the invention.

The software processes can be configured as system modules such that a search engine is utilized in step 201 of FIG. 1A and an output display module is utilized at the transaction server to generate various tables, Table A-H. To avoid further bidding on diamond that have been sold, the system includes a disablement software module which disables all further buys or bids when either the offer to sell has been withdrawn by the seller or in the presence of a sold stone event indicating the sale of a unique stone. Supplemental output display modules are utilized which permit either the authentication service or courier to view the stone unique lab certificate. Transaction costs are computed by a transaction charge module.

The following “My Purchases (or Sales)” Table shows general transaction history and includes the data from purchases or sales tables discussed above as well as: date transaction was complete, the current status of transaction, the funds release date and the goods accepted date.

My Purchases (or Sales) Table

```
transaction number
initiation date (initial posting of offer date or last bid post date)
diamond characteristics
          cut
          carat
          color
          clarity
    Grade Lab certificate
total transaction cost this diamond
Supplier-Vendor
Status: funds secured; goods in transit; goods certified; goods at buyer
Transaction History (above data plus date transaction complete; status:
funds released; goods accepted)
```

FIG. 4 shows a one type of diamond record. Other diamond record formats may be used.

FIG. 3 shows various financing methods for the transactional system which the buyer may employ to purchase the diamond. Oftentimes, the seller will dictate the type of financing option. At other times, the buyer will have some input into which purchasing option may be employed. In any event, step 250 shows buyer's purchasing options by the transactional system. Step 252 is a cash market transaction. In this situation, buyer 251 presents various authorizations (“AUTHOR”) to various financial institutions or designees which effectively transfer money to the system operator bank 255. One trading platform system requires that the buyers sign a pre-authorization for an ACH or electronic finds transfer authorization when the buyer selects the “buy now” hot button for a designated stone. In one situation, the system operator upon a “buy now” command, presents a buyer authorization “B author” (ACH command) to a buyer's bank or financial institution 253. The bank or other financial institution 253 (generically referred to herein as “bank”) preferably sends an electronic funds transfer EFT to the system operator bank or system operator financial institution 255. An electronic funds transfer EFT communication is sent from the system operator's bank to the system and this communication is logged as part of the sold stone event. This communications event indicates that funds have been transferred. Buyer's bank 253 may alternatively send an electronic check (Elec-ck) to the system bank 255. In some situations, the buyer may send a paper check (ck) by land, mail, courier, or whatever to the system operator bank 255. In general, this latter transaction is identifier as a “land” transaction since a paper check is physically presented to the system operator bank 255. Land transactions require longer clearance times. An ETF-ACH transaction currently needs 48 hour clearance time to irrevocably transfer the “buy diamond now” finds to the system bank 255. Further, the buyer may have an account with the system operator, in the system operator's bank, wherein the buyer can “draw-down” monies needed to purchase stones via the transactional system. After such clearance of funds time period, the diamond is picked up by electronic communications sent to a trusted courier.

In other financial situations, buyer 251 may have established a letter of credit with the system operator bank 255. In general, this letter of credit involves issuance of a buyer's authorization to a buyer's account 258, subject to the letter of credit, which authorization results in a freezing, seizure, lien or transfer of the specially identified funds to buy the diamond in favor of the system operator 257 and against buyer 251. The letter of credit may have a “freeze finds” clause when the buy now command is logged and a “release funds” clause when the stone is delivered to the seller and confirmation is provided. In other situations, buyer 251 may have established a buyer's account 259 at the system operator's bank 255. In this situation, the buyer presents information and electronic instruction communications to system operator's bank 255 such that predetermined transaction amount is transferred from buyer's account 258 to system account 255. After such finds are transferred or otherwise secured to the exclusive benefit of the system operator, the buyer no longer has the right to withdraw or otherwise encumber the “secured” funds for the diamond transaction. Alternatively, the buyer may pre-pay an amount in an account with the system operator's bank account.

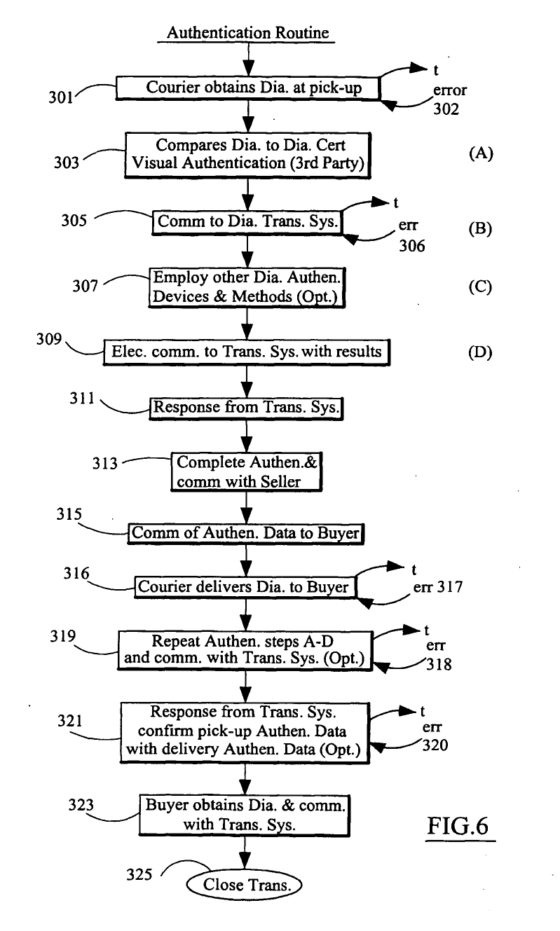

In different financial situations, the buyer may use a trusted third-party payor 261. The buyer 251 may give authorization to the trusted third-party payor 261 (for example, Paypal) and an electronic fund transfer EFT is sent from third-party 261 to the system operator bank 255. The trusted third-party 261 may be electronically linked to a buyer's credit card and the trusted third-party 261 may communicate with the buyer's credit issuer 263 to obtain credit card money for the transaction. With respect to many of these authorizations from buyer 251, a return confirmation or communication is noted from the buyer's bank 253, the system operator's bank 255 relative to buyer's account 259, and/or the trusted third-party payor 261. In any event, the system operator freezes or secures or transfers the transaction amount for the cash transaction diamond sale and that securitization or transfer of the predetermined funds is noted by a communications event in the sold stone event in the diamond transaction system computer 257. Once the funds are secured by the diamond transaction system 257, the system, in step 254, logs in the transaction as a cash transaction. Other delivery and independent certification steps are then processed as discussed in FIGS. 1A and 1B and in FIG. 6.

If a cash transaction 252 is not selected by the parties, a memo transaction 256 may be processed. This memo transaction involves utilization of a seller contact or profile 265 and a buyer's contact or profile 251. These “user” profiles are well established in computer systems and include name, address, contact information, email, and other relative information for both the buyer and the seller. This information is generally proprietary to the buyer as well as the seller. However, in a memo transaction, the seller's profile must have adequate information to support a high level of trust with the buyer. Therefore, some or all of the buyer's profile is made available to the seller for the memo transaction or the conditional sale. An important aspect of a memo transaction is the documentation of the terms of the memo and the completion of the memo. Therefore, the memo transaction may have two data records which include inventory graphic module or record 267 and memo loan out graphic module or record 269. As used herein a “graphic module” refers to a record. It should be noted that other record formats may be used and the graphic module records may be combined or separated to speed processing of the transaction and in accordance with data collection and processing standards and techniques. The inventory graphic module 267 includes a diamond record, as well as the purchase price of the diamond (the inventory value), and an indication or record indicia Y/N indicates whether the diamond is subject to a memo conditional sale.

On the memo-loan out graphic module 269, the data record shows the memo amount, the prospective buyer, the date the memo was issued, the term of the memo (30, 60, 90 days), the expiration or expiry date, and the number of days left to the expiration of the memo. The data record, which includes inventory graphic module 267 and memo loan out module 269, also includes total quantity Q, a range marker such as 1.0 carats-1.09 carats, and a total value of all the diamonds (in the range) subject to a memo (range groupings may be deleted). In the memo-loan out graphic module 269, the same range is noted. Therefore, a seller, by looking at inventory graphic module 267 and memo loan out graphic module 269, has a view of his or her entire inventory on hand and a view of his or her entire inventory which is loaned out via memos.

With respect to the buyer's profile and the memo inventory 267 and the memo loan data 269, the same or substantially similar data is provided to the buyer holding the goods per memos. From the buyer's standpoint, he or she should know how much he or she has in inventory which is called herein the “memo inventory” 267. The memo inventory 267 usually the same data as the inventory 267 from the buyer's side. In other words, the buyer has a list of all stones in inventory which are subject to memo or being loaned to the buyer. On the other side of the transaction, the memo loan data 269 contains substantially the same information as the memo-loan out data structure 268 for the seller except the buyer's memo loan data 269 includes the name of the supplier “memo supplier” rather than the name of the prospective buyer. Totals are also provided in memo inventory 267 on the buyer's side and memo loan data 269 on the buyer's side. In step 258, the system logs in the memo data in the transaction system and subsequently when the stone is delivered to the buyer an acceptance is noted as indicated above in the program at FIGS. 1A, 1B. The system logs in the memo sale. Typically, that memo transaction is not a cash transaction but, when the memo transaction is converted in a cash transaction, the sale data may be processed at other locations in the system, not typically in the cash data Market Table.

If the transaction is not a cash transaction or a memo transaction, a credit transaction 260 may be processed. In this situation, buyer 561 communicates with a credit provider in step 273 which may be the buyer's bank, the seller's bank, the system operator's bank, a third-party credit provider or a third-party guarantor. In any event, money is transferred to the system operator bank 255 by the credit provider selected in step 273. Of course, some buyers may have long standing credit and loan relationships with credit provider. In other situations, the buyer maybe required to establish a new credit or a new line of credit from a credit provider. In any event, the details of the transaction are logged-in in step 262. The further details of the credit transaction effectively follow a cash transaction process. In step 264, the system continues with the transaction process as described earlier in FIGS. 1A and 1B.

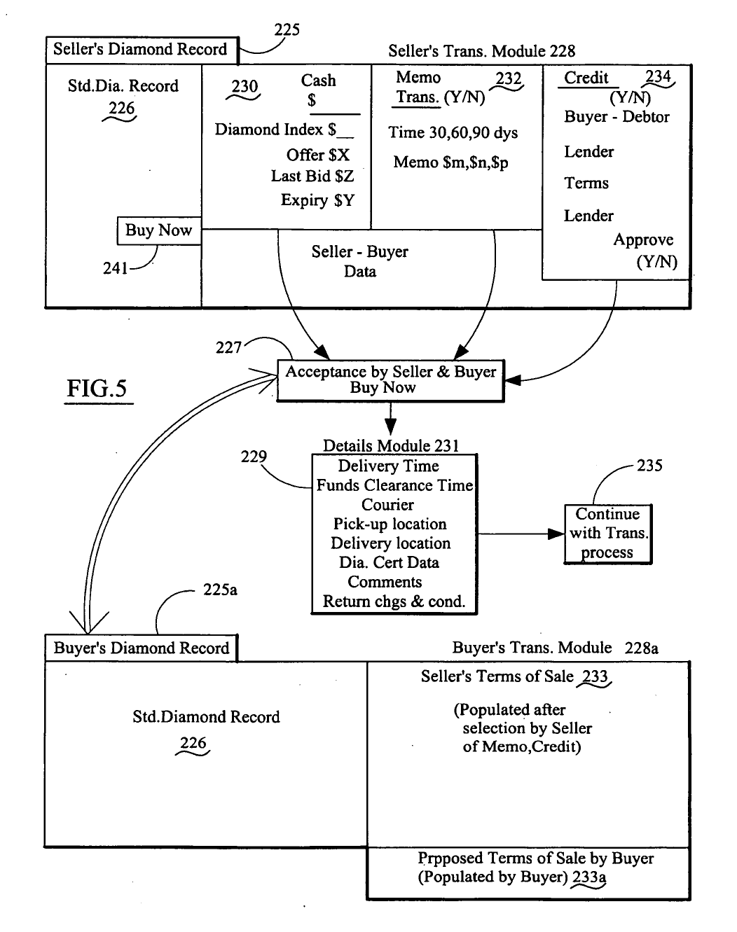

FIG. 5 graphically shows various records and processing relationships between the records. A seller's transaction record 225 includes diamond record data 226 (see example in FIG. 4) and a seller transaction model graphic module 228. The seller's module may include a “buy now” hot link 241 as explained earlier. The seller transaction graphic module 228 may be truncated or may be expanded to show a cash market offer, details for a memo transaction and/or details of a credit transaction. In other words, the seller may have one price for the diamond shown in diamond record 226 for the cash market, a different price and different terms when the diamond in record 226 is a memo transaction and a further different price for a credit transaction. Sometimes, the seller transaction graphic module 228 includes only one of these items such as cash graphic module 230 or memo graphic module 232 or credit graphic module 234. Graphic module 230 may include reference to a diamond pricing metric or standard for the class of diamond within which the selected diamond is classified. See “Diamond Index.” Also the offer to sell data, and bid control bar or the leading bid (in order of primacy) is listed. Sometimes, the seller selects yes or no (Y/N) in one or all of cash graphic module 230, memo graphic module 232 or credit graphic 234. The seller completes memo graphic module 232 with data such as time for the diamond to be on loaned to the buyer, such as 30 days, 60 days and 90 days, as well as a memo amount which must be paid by the buyer if the stone is sold within each of those periods $m, $n and $p. Credit graphic module 234, if selected (Y/N), includes information about the buyer or debtor, the third party lender (or seller or system operator financing terms), the terms for the credit transaction and lender approval or disapproval (Y/N and an approval code). Some of the information in the seller transaction graphic module 228 is completed based upon multiple communications with the seller.

In functional step 227, an acceptance occurs with a “buy now” function between the buyer and seller for the type of financing (cash, memo transaction or credit) for the sale of the diamond or precious stone. In some situation, a memo transaction may be classified as a conditional sale. In step 227, a buyer's diamond record 225a is created which has the standard diamond record 226 which clearly identifies the goods subject to the transaction and a buyer's transaction graphic module 228a. The terms of sale graphic module 233 is populated after selection by the seller of the type of sale such as a cash sale, memo sale or credit and the data for that sales process. If a credit sale, further interaction with a third party lender may be required to establish credit worthiness of the buyer and time to deliver finds to the system operator by the credit provider. Of course, the term of sale graphic module 233 for a cash transaction is simply the current offer to sell price as well as other “Details” shown in step 229. Detail step 229 includes a detail graphic module 231 which includes other details regarding the transaction such as the delivery date, limits on delivery times, the pick-up time for the goods, the delivery time of the goods to the buyer, the funds clearance time (the amount of time between the logged transaction (agreed-upon buy-sell time) and the time the system operator secures the buyer's finds), the courier, identification of the courier, the pick-up location, the delivery location, diamond certificate data, any comments unique to the transfer of the goods, the return charges and any further conditions. Step 235 continues with the transaction process as discussed above in connection with FIGS. 1A, 1B.

A transport and authentication routine is described in connection with FIG. 6. The authentication routine occurs both at the seller side when the courier picks up the stone as well as at the buyer side. Transparent communications is one of several important aspects of the system. The system may be set to send numerous communications to both buyer and seller or simply permit buyer or seller to access the sold stone event data. In step 301, the system sends a pick-up instruction to a trusted diamond courier and the courier picks up the diamond at the pickup location.

The system may have a time and place error routine 302 that monitors all aspects and timing of the diamond transport until the time the diamond is placed in the hands of the buyer or his or her agent. Time is monitored and place or location of communication may be monitored. Place can be monitored with global positioning systems or by matching a predicted time-location record with the communication event data input by the transport or inspection party as an acknowledgment or per system required check-in times and dates and places. The i.p. address of the client computer may be used to track geographic location of the stone at pick-up, inspection, interim pick-up and delivery. The transaction server notes the i.p. address at log-in transit points and times. One detailed time and place error routine includes (a) predicting the time of pick-up from the seller's location; (b) requiring the seller and/or the courier to communicate with the system at that time; (c) the system checks the courier phone number and/or G.P.S. location or network device i.p. address and correlates the same to the seller's location; (d) predicting the time for the courier to arrive at the inspection authentication service; (e) having the authentication service initiate a communication event with the system that the stone has arrived; (f) the system checks if the party making the call is calling from the authentication service's telephone (caller number recognition) (voice recognition and IVR services may be employed); (g) predicting the time to complete the independent authentication; and (h) continuing this prediction and required call-in confirmation by the trusted courier and the trusted authentication service at numerous times until the stone is delivered to the buyer.

In the event an error is noted (see time-place error routines 302, 306, 317, 318 and 320), the system may increase the communications events with the trusted courier and the trusted authentication service. Automated voice call-outs (or emails or text messages) at increasing frequencies to the courier and authentication service are first initiated. When greater deviations from the predetermined time and place parameters are noted, the system generates more communications up the management chain in the system operator. The buyer, seller, courier and inspection service profiles have higher management contact persons with different communication methods and contact data. Also, the users (sellers and buyers) may have hierarchal user profiles with management contacts therein with different communications channels which require notification. Greater deviations from predicted time and place cause increasingly greater communication events per the hierarchical management contact and channel listings. Higher value transactions may require more frequent communication events or increasingly higher management notices. The Communication Table below present one type of increasingly greater hierarchal management contacts with different communications channels.

Communication Table

| | |
|---|---|
| low | email contact to seller system |
| level 1 | voice message to seller 1^{st} level administrator |
| level 2 | 2^{nd} voice message to seller 1^{st} level administrator, email to 2^{nd} |
| | level admin and email to buyer admin |
| level 3 | email, voice and text message to top level seller and buyer |

In step 303, the courier delivers the stone to an independent grading lab or certified person who physically compares the diamond to the diamond certificate and provides a visual authentication of the stone to the grading certificate on-line in the system. In step 305, an inspection communication event (phone call, IVR message, web based input etc.) is initiated by the authentication service and sent to the diamond transaction system. That “inspection approved” communication is logged in to the system with the sold stone event. In addition, in step 307, the courier or authentication service may employ other diamond authentication devices and methods. The Authentication List which follows provides a general list of different types of authentication devices which may be employed in the system. In the event of a machine authentication, in step 309, an electronic communication is optionally established between the authentication device and the transaction system, that is, the data generated by the use of the supplemental authentication device is uploaded to the transaction platform. Some authentication devices listed in the Authentication List provide an electronic output. The electronic output is sent to the transaction system and logged into the transaction system. In step 311, a response (acceptance) is obtained from a transaction system. If the diamond certificate correlates with the data from the authentication device, an electronic match therebetween establishes the relationship between the authentication device data and the diamond certificate or other electronic data stored for that diamond and the transaction system. In step 313, the authentication is complete and this data is communicated to the seller. The courier then again picks up the diamond and logs in with the system to confirm interim pick-up. In step 315, a communication of authentication and interim pick-up is sent to the buyer by the system. In step 316, the courier delivers the diamond to the buyer and a communication is logged in the data record.

In step 319, the system optionally repeats authentication steps A-D at the buyer's location and a communication is established with the transaction system. In step 321, a response from the transaction system confirms that the pick-up authentication data matches the delivery authentication data. In other words, if a certain authentication is employed at the front end at the pick-up location, an identical authentication routine maybe employed at the delivery end or back end at the delivery location. The electronic authentication data at the time of pick-up must match the authentication data at the time of delivery. If a match occurs, then the buyer in step 323 must accept the diamond. In any event, if the buyer rejects the diamond, the system operates in accordance with the transactional system discussed earlier in FIGS. 1A, 1B. In step 323, the buyer accepts diamond and communicates with the transaction system. In step 325, the transaction system method ends. In the current, working embodiment, a single inspection is used and this clears the transaction and closes the sale.

### Authentication List

U.S. Pat. No. 6,473,164, Systems, apparatuses and methods for diamond color measurement and analysis
U.S. Pat. No. 7,001,038, Feb. 21, 2006, Method and apparatus for object viewing, observation, inspection, identification, and verification, Bock, Joel N
U.S. Pat. No. 6,683,680, Jan. 27, 2004, Method, system and device providing a musical representation of a transparent or translucent structure, Dinu, Nicolae
U.S. Pat. No. 6,352,151, Mar. 5, 2002, Jewelry box having attached segmented lid member, Stewart, Glenn
U.S. Pat. No. 6,331,708, Dec. 18, 2001, Examining a diamond, Smith, Martin Phillip
U.S. Pat. No. 6,265,884, Jul. 24, 2001, Electrical conductivity gem tester, Menashi, Solomon
U.S. Pat. No. 6,014,208, Jan. 11, 2000, Examining a diamond, Welbourn, Christopher Mark
U.S. Pat. No. 5,883,388, Mar. 16, 1999, Examining a diamond, Smith, Martin Phillip
U.S. Pat. No. 5,880,504, Mar. 9, 1999, Examining a diamond, Smith, Martin Phillip
U.S. Pat. No. 5,828,405 to Vanier “Gemstone Registration System Oct. 27, 1998
U.S. Pat. No. 5,811,824, Sep. 22, 1998, Method and an apparatus for testing whether a diamond has a layer of synthetic diamond deposited thereon, Smith, Martin Phillip
U.S. Pat. No. 5,124,935 to Wallen “Gemstone Identification, Tracking and Recovery System, Jun. 23, 1992.
U.S. Pat. No. 4,275,810 Package for Diamonds

The discussion above involves a cash market transaction and a credit transaction. The memo transaction (conditional sale) involves a high level of trust between the buyer and the seller. In other words, the seller must trust the buyer to honor the memo or return the diamond subject to the transaction within the time specified in the memo. In a pure credit transaction, the buyer establishes credit with a credit provider and the seller obtains or secures the funds from the credit provider (currently, the system operator obtains the funds) and therefore this type of pure credit transaction is closer to a cash or market transaction than the memo transaction.

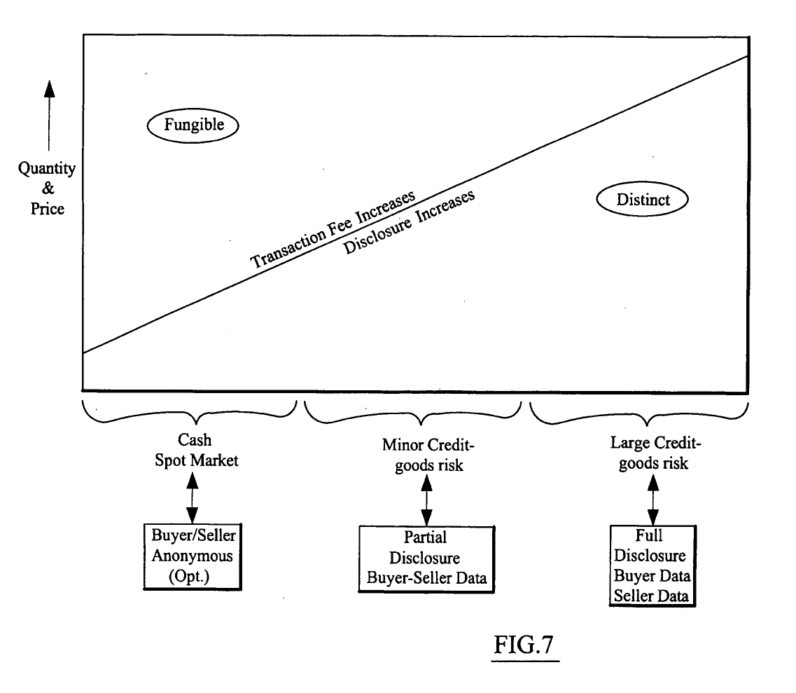

FIG. 7 shows that there is a relationship between quantity and price of the diamond subject to the transaction (vertical axis) and several other aspects which impact the sale such as the amount of necessary disclosure of the buyer's identity (and possibly of the seller's identifying information) as well as the risk or probability that the transaction will not be completed (with the delivery and the acceptance of the stone by the buyer) and valuation factors. Prior to discussing the diagram in FIG. 7, the following aspects of system credit or conditional sale should be noted.

The seller's profile, in addition to the components discussed above, has certain data and historic user data which provides an analytical basis to determine the risk associated with the transaction, that is, the risk that the transaction will not be completed. This user data includes the amount of sales made by the seller through the transactional system, the transaction frequency, the average transactional value and total, the number of deliveries completed and number of closed transactions. The number of total returns and number of “specific reason” returns is also noted. Total returns ignores the basis for the return, that is, whether due to seller or buyer issues or conditions. The “specific reason” returns is the number of “bad goods” or “lost goods” or failure to satisfy pick up authentication (a type of return) and the total number of times the seller has engaged the transactional system and total sales volume. The buyer's profile includes a buyer profile user data including the amount of sales the buyer has made through the transactional system, the dollar amount of returns of the sales, the total number of returns, the number of returns caused by defects at the delivery point, the amount of time the buyer has used the transactional system, whether or not the buyer has a banking relationship with the transactional system operator's bank, the buyer's credit history rating and the buyer's memo credit history and memo data discussed above.

The system operator's credit conditional sales module includes transactional analysis which includes the dollar amount of the current transaction, the type of transaction, the time to secure funds to carry out the transaction subject to analysis, any seller conditions opposed upon the particular transaction, the total amount of system operator credit involved and any conditions placed on the system operator by the operator's bank.

Returning to FIG. 7, when the price or the quantity of the transaction is low, there is a low transaction fee and a low or nominal disclosure of buyer-seller identity. On the left side of FIG. 7, this area is generally classified a “fungible” territory representing quick transactions, with low fees and quick deliveries and low risks. In the event of a disruption of the transaction of any nature, it is relatively easy to substitute one diamond for another diamond at that most price levels. It is at this area that the cash spot market operates. This fungible territory represent true, real time market transactions for the diamonds. Further, in the fungible area, the buyer and/or the seller may be anonymous to each other. This may be beneficial in certain situations.

As either the quantity of the diamond sale increases (multiple singles sales, parcel sales or pair sales) or the price increases (price per carat or total transaction price for single, parcel or pair prices), the transaction fee increases and the amount of disclosure of the buyer's data to the seller increases. In other words, the quality of buyer data and seller data is more important as higher value independent transactions are noted or tracked by the system. On the right side of FIG. 7, a “distinct” classification area is noted wherein the price or the quantity or the uniqueness of the diamond is so critical that a full disclosure of the buyer data and possibly full disclosure of the seller data is required. At the distinct side of the system, a large credit risk or “risk of failure to close” the transaction arises. In other words, the buyer may want a higher levels of authentication and confirmation of the goods in the distinct area. Intermediate the “fungible” and the “distinct” areas is a “minor credit risk” or moderate risk of return. A partial disclosure of the buyer or the seller data may be necessary. System analysis of the buyer or seller may occur automatically in this intermediate area. The system may flag certain buyers or alter transaction fees or authentication procedures based up the value-risk ranking. The system may also “grade” the buyer or seller based upon his or her transaction history. Therefore, the more diamonds handled by a seller and the more diamonds handled by a particular buyer, the higher confidence level the system operator has that there is a reduced likelihood of “return risk”.

By compiling the information for a credit conditional sale profiles (memo sales) and providing data analysis therefor, the system operator can determine whether the risk of non delivery or risk of rejection is acceptable for a particular transaction and therefore increase or decrease the transaction fee as well as the amount of disclosure of the buyer or seller identity in relation to the transactional history of the seller, transactional history of the buyer and the system operator limits.

### General System Operational Aspects

The present invention relates to a computerized bid matching method and system for diamond sales with data provided by vendors and buyers. Throughout the description of the present method and system, abbreviations are sometimes utilized describing certain features. The following Abbreviations Table lists these items. FIG. 1A shows a short version of the transactional system.

Abbreviations Table

| | |
|---|---|
| # | number |
| acct | account |
| add | address |
| admin | Administrator - system operator |
| author | authorize, as in authorize a money transfer |
| cert. | certificate |
| comm. | communications (e-mail, electronic response requested, |
| | telephone call contact) |
| ct | carat |
| cc | copy correspondence to another designated party |
| comp. | computer system |
| cpu | central processing unit |
| cr | credit |
| cr.cd. | credit card |
| db | Database or spread sheet or data array |
| D. Sch. | diamond search |
| dia | diamond |
| disp | display |
| err | error routine |
| F | function |
| fnc | function |
| Fin. Inst. | financial institute |
| id | identify |
| I/O | Input-Output device (e.g., I/O for keyboard, modem etc.) |
| ltr. cc | letter of credit |
| mem | memory |
| opt | optional |
| org. | organization |
| p.c. | price per carat |
| rcd | record or records (rcds) |
| req'd | required |
| rev. | reverse, such as reverse funds transfer |
| RFQ(s) | Request for proposal(s) or an offer |
| rqmts | requirements |
| rqt | request(s) |
| sel | Select |
| stats | statistics |
| S&H | shipping and handling |
| sys. | System |
| t | time |
| tel. comm. | Telecommunications Center with voice communications |
| center | |
| tel. comm. sys. | Telecommunications System |
| t err | time or place error |
| trans. | transaction |
| w/d | withdraw |
| yr | year |
| Y/N | Yes/No selection |

FIG. 8A diagrammatically illustrates the global telecommunications system 10 (includes the Internet, land lines, cable, cell phone, satellite and other carriers) which enables communication and data transport between a plurality of relatively independent computer systems 12, 14, 16, 17, 18 and 20. Computer system 12 includes monitor 22, input device or keypad 24, input device or mouse 26, and processor unit 28. Other computer network devices (see PDA 15C) may be simpler. Processor unit 28 includes a central processing unit or CPU 30, memory 32 and an input/output or I/O device 34. It should be noted that memory 32 represents many types of data storage including hard drives, volatile and non-volatile memory, and removable drives. Also, I/O 34 represents a plurality of input/output devices which are utilized to couple items which are peripheral to processing unit 28. I/O 34 is connected to communications network 10. Computer 17 is a laptop computer which can easily be disconnected from communication network 10. Computer 18 is an administrative computer which assists in the overall control and operation of the system and the method described herein. Computers 12, 14, 16 and 17 are client computer systems operated by vendors and buyers and couriers and authentication services and customers who seek data or plan to purchase goods or services via the communication network from vendors.

In a preferred embodiment, the system and method are deployed on Internet 10 (part of the network) via computer system server 20. Server 20 includes CPU 36, memory 38 and I/O 40, and is coupled to Internet network 10.

In a different embodiment of the present invention, the system or processing system or method may be partially carried out with the use of a telephone communications center 42. The telephone communications center typically includes one or a plurality of computers 44 and one or more telephones 46. Human operators may answer telephone inquiries from a customer or vendor seeking information. The input of information can be facilitated by a person at telephone communication center 42. For example, computer 44 could display questions which the operator could audibly present via telephone 46 to a caller. The operator would input into computer 44 the caller's answers and system 44 could generate appropriate responses to complete data entry forms for the system. IVR 46a is an interactive voice response system to facilitate electronic communications via the network to land line telephone 15a, cell phone 15b which may be a network device and personal data assistant PDA 15c, another network computer device.

The present invention relates to a trading platform and a methodology therefor on a computer network (LAN or WAN) and over the Internet and computer programs, computer modules and an information processing system to accomplish this trading system.

It is important to know that the embodiments illustrated herein and described herein above are only examples of the many advantageous uses of the innovative teachings set forth herein. In general, statements made in the specification of the present application do not necessarily limit any of the various claimed inventions. Moreover, some statements may apply to some inventive features but not to others. In general, unless otherwise indicated, singular elements may be in the plural and vice versa with no loss of generality. In the drawings, like numerals refer to like parts or features throughout the several views.

The present invention could be produced in hardware or software, or in a combination of hardware and software, and these implementations would be known to one of ordinary skill in the art. The system, or method, according to the inventive principles as disclosed in connection with the preferred embodiment, maybe produced in a computer system having separate elements or means for performing the individual functions or steps described or claimed or one or more elements or means combining the performance of any of the functions or steps disclosed or claimed, or may be arranged in a distributed computer system, interconnected by any suitable means as would be known by one of ordinary skill in the art.

According to the inventive principles as disclosed in connection with the system embodiments, the invention and the inventive principles are not limited to any particular kind of computer system but may be used with any general purpose computer, as would be known to one of ordinary skill in the art, arranged to perform the functions described and the method steps described. The operations of such a computer, as described above, may be according to a computer program contained on a medium for use in the operation or control of the computer as would be known to one of ordinary skill in the art. The computer medium which may be used to hold or contain the computer program product, may be a fixture of the computer such as an embedded memory or may be on a transportable medium such as a disk, as would be known to one of ordinary skill in the art. Further, the program, or components or modules thereof, may be downloaded from the Internet of otherwise through a computer network.

The invention is not limited to any particular computer program or logic or language, or instruction but may be practiced with any such suitable program, logic or language, or instructions as would be known to one of ordinary skill in the art. Without limiting the principles of the disclosed invention any such computing system can include, inter alia, at least a computer readable medium allowing a computer to read data, instructions, messages or message packets, and other computer readable information from the computer readable medium. The computer readable medium may include non-volatile memory, such as ROM, flash memory, floppy disk, disk drive memory, CD-ROM, and other permanent storage. Additionally, a computer readable medium may include, for example, volatile storage such as RAM, buffers, cache memory, and network circuits.

Furthermore, the computer readable medium may include computer readable information in a transitory state medium such as a network link and/or a network interface, including a wired network or a wireless network, that allow a computer to read such computer readable information.

In a preferred embodiment, inquiries regarding goods or services are obtained by utilizing a web browser or other type of interface on a user's computer 12 (a client computer) as deployed by server 20. The information obtained by computer 12 is generally stored in server 20. Thereafter, the information is processed by server 20 and the output information representing processed data is delivered to the user via Internet 10, and ultimately to user or client computer 12. FIG. 8B shows that data input by a customer is sent to the server 20 which returns further web page data A4.

Although the system and method is described generally for use in conjunction with communications network and Internet 10, the system and method could be accessed by a single computer, such as laptop computer 17, operated locally on a local area network. Laptop 17 could be utilized with a CD-ROM storing a major portion of the data bases necessary to carry out the principles of the present invention. Since the bidding process involves a complementary party, that portion must be interactive over a communications channel. Further, the information processing system could be deployed over a local area network or a wide area network or utilized exclusively in-house by a single company with subsidiaries bidding goods.

The claims appended hereto are meant to cover modifications and changes within the scope and spirit of the present invention.

What is claimed is:

1. A computerized method for facilitating the sale and purchase of precious stones or diamond stones over a computer network and a communications network with a computer-based data collection, said data collection storing data representing said stones including at least stone weight and at least one other stone characteristic for each said stone and a grading lab certificate uniquely identifying each said stone from all other stones in said data collection and including an offer to sell each said stone input by sellers and including bids to buy selected stones selectively input by prospective buyers, the method comprising:
searching said data collection based upon one or more inquiries and facilitating a display on an inquiring party's computer network device of stones which match said inquiries wherein the display data includes at least one stone, its corresponding stone weight, characteristic, electronic access to said stone's unique lab certificate identifying said one stone from all other stones in said data collection and a corresponding offer to sell;
facilitating, as part of said display for said at least one stone, both a buy command functional display and a bid command functional display;
upon activation of said buy command, communicating a sold stone event to a respective seller of said one stone and an inquiring prospective buyer at said corresponding offer to sell;
upon activation of said bid command, accepting and storing in said data collection a respective bid to buy data which includes at least a bid price from said inquiring prospective buyer;
accepting further bid to buy data for said one stone from either said inquiring prospective buyer or other inquiring prospective buyers and storing respective bid to buy data until withdrawal of said offer to sell said one stone by said respective seller or said sold stone event.

2. A computerized method for facilitating the sale and purchase of precious stones or diamonds as claimed in claim 1 wherein said electronic access to said one stone's unique lab certificate permits said inquiring party to uniquely identify said one stone from all other stones in said data collection and including the step of facilitating an accept bid command which further includes communicating a sold stone event to said seller of said one stone and said inquiring prospective buyer at said corresponding offer to sell.

3. A computerized method for facilitating the sale and purchase of precious stones or diamonds as claimed in claim 1 said activation of said buy command is mutually exclusive of said activation of said bid command.

4. A computerized method for facilitating the sale and purchase of precious stones or diamonds as claimed in claim 1 wherein said bid to buy data includes expiry data, either supplied by said inquiring prospective buyer or computed based upon said bid price or acceptance thereof.

5. A computerized method for facilitating the sale and purchase of precious stones or diamonds as claimed in claim 4 wherein upon activation of said bid command, the method includes facilitating a compiled bid display to said inquiring prospective buyer or other inquiring prospective buyers which includes stored bid to buy data for said one stone.

6. A computerized method for facilitating the sale and purchase of precious stones or diamonds as claimed in claim 5 wherein said compiled bid display is organized based upon predetermined primacy factors of said stored bid to buy data.

7. A computerized method for facilitating the sale and purchase of precious stones or diamonds as claimed in claim 6 wherein said expiry data represents a bid validity time period and wherein said predetermined primacy factors are first based upon said bid prices in said stored bid to buy data and second based upon near term expiration of bid validity time periods.

8. A computerized method for facilitating the sale and purchase of precious stones or diamonds as claimed in claim 1 wherein said sold stone event includes permitting access to said one stone's unique lab certificate by a precious stones or diamonds courier having a respective computer network device coupled to said computer network.

9. A computerized method for facilitating the sale and purchase of precious stones or diamonds as claimed in claim 1 wherein said sold stone event includes permitting access to said one stone's unique lab certificate by an independent precious stones or diamonds authentication service having a respective computer network device coupled to said computer network.

10. A computerized method for facilitating the sale and purchase of precious stones or diamonds as claimed in claim 1 wherein said sold stone event includes assessing a transaction charge on one or both of said respective seller or said inquiring prospective buyer, said transaction charge related to said corresponding offer to sell said one stone, said transaction charge including one or more of a shipping and handling charge for transport of said one stone and a transaction fee.

11. A computerized method for facilitating the sale and purchase of precious stones or diamonds as claimed in claim 10 including upon activation of said buy command, displaying said transaction charge with said corresponding offer to sell said one stone and including upon activation of said bid command, displaying said transaction charge with said bid price.

12. A computerized method for facilitating the sale and purchase of precious stones or diamonds as claimed in claim 1 wherein the method operates on only diamond stones, said diamond stones being (a) a plurality of single diamonds; (b) a plurality of matching pairs of single diamonds; and (c) a plurality of matching sets of single diamonds;
said data collection storing data representing:
for each matching pair of said plurality of matching pairs of single diamonds, at least total stone weight data and individual stone weight data for each stone in said matching pair, and a grading certificates for each stone in said matching pair;
for each matching set of said plurality of matching sets of single diamonds, at least total stone weight data and individual stone weight data for each stone in said matching set, and a grading certificates for each stone in said matching set;
said searching and facilitating said display including permitting electronic access to said single stone unique lab certificate, said grading certificates for each stone in said matching pair, and said grading certificates for each stone in said matching set, which grading certificates uniquely identify the selected stones or stone from all other stones in said data collection.

13. A computerized method for facilitating the sale and purchase of precious stones or diamonds as claimed in claim 1 wherein the method operates on only diamond stones, said diamond stones being (a) a plurality of single diamonds; (b) a plurality of parcels of single diamonds; (c) a plurality of matching pairs of single diamonds; and (d) a plurality of matching sets of single diamonds.

14. A computerized method for facilitating the sale and purchase of precious stones or diamonds as claimed in claim 12 wherein said other stone characteristics include cut, color, clarity of said stones.

15. A computerized method for facilitating the sale and purchase of precious stones or diamond stones over a computer network having a plurality of computers operatively coupled together over a communications network with a computer-based data collection, said data collection storing data representing said stones including at least stone weight and at least one other stone characteristic for each said stone and including an offer to sell each said stone input by sellers and bids to buy selected stones selectively input by prospective buyers, said data collection also including contact data for said sellers and for said prospective buyers, the method comprising:
searching said data collection based upon one or more inquiries from sellers or prospective buyers and facilitating a display on an inquiring party's computer of stones which match said inquiries wherein the display data includes at least one stone, its corresponding stone weight, characteristic and offer to sell;
facilitating, as part of said display for said at least one stone, both a buy command functional display and a bid command functional display which commands are mutually exclusive;
upon activation of said buy command by an inquiring prospective buyer, communicating a sold stone event between a respective seller of said one stone and said inquiring prospective buyer at said corresponding offer to sell;
upon activation of said bid command by said inquiring prospective buyer for said one stone, accepting and storing a respective bid to buy data which includes at least a bid price and expiry data in said data collection;
accepting and storing in said data collection further bid to buy data for said one stone from either said inquiring prospective buyer or other inquiring prospective buyers and displaying said further bid to buy data based upon predetermined primacy factors until withdrawal of said offer to sell said one stone by said respective seller or said sold stone event.

16. A computerized method for facilitating the sale and purchase of precious stones or diamonds as claimed in claim 15 wherein said expiry data of said bid to buy data is either supplied by said inquiring prospective buyer or computed based upon said bid price or acceptance thereof.

17. A computerized method for facilitating the sale and purchase of precious stones or diamonds as claimed in claim 16 wherein upon activation of said bid command, the method includes facilitating a compiled bid display to said inquiring prospective buyer or other inquiring prospective buyers which includes stored bid to buy data organized based upon predetermined primacy factors of said stored bid to buy data.

18. A computerized method for facilitating the sale and purchase of precious stones or diamonds as claimed in claim 17 wherein said expiry data represents a bid validity time period and wherein said predetermined primacy factors are first based upon said bid prices in said stored bid to buy data and second based upon near term expiration of bid validity time periods.

19. A computerized method for facilitating the sale and purchase of precious stones or diamonds as claimed in claim 18 wherein:
data collection including grading lab certificate data for each of a plurality of stones therein, said grading lab certificate uniquely identifying each said stone from all other stones in said data collection;
said searching and facilitating said display of said at least one stone includes permitting electronic access to said one stone's unique lab certificate identifying said one stone from all other stones in said data collection;
said sold stone event includes permitting access to said one stone's unique lab certificate by one or both of:
a precious stones or diamonds courier having a respective computer network device coupled to said computer network, and
an independent precious stones or diamonds authentication service having a respective computer network device coupled to said computer network.

20. A computerized method for facilitating the sale and purchase of precious stones or diamonds as claimed in claim 19 wherein said sold stone event includes assessing a transaction charge on one or both of said respective seller or said inquiring prospective buyer, said transaction charge related to said corresponding offer to sell said one stone, said transaction charge including one or more of a shipping and handling charge for transport of said one stone and a transaction fee.

21. A computerized method for facilitating the sale and purchase of precious stones or diamonds as claimed in claim 20 wherein the method operates on only diamond stones, said diamond stones being (a) a plurality of single diamonds; (b) a plurality of matching pairs of single diamonds; and (c) a plurality of matching sets of single diamonds;
said data collection storing data representing:
for each matching pair of said plurality of matching pairs of single diamonds, at least total stone weight data and individual stone weight data for each stone in said matching pair, and a grading certificates for each stone in said matching pair;
for each matching set of said plurality of matching sets of single diamonds, at least total stone weight data and individual stone weight data for each stone in said matching set, and a grading certificates for each stone in said matching set;
said searching and facilitating said display including permitting electronic access to said single stone unique lab certificate, said grading certificates for each stone in said matching pair, and said grading certificates for each stone in said matching set, which grading certificates uniquely identify the selected stones or stone from all other stones in said data collection.

22. A computerized method for facilitating the sale and purchase of precious stones or diamonds as claimed in claim 21 wherein said other stone characteristics include cut, color, clarity of said stones and including the step of facilitating an accept bid command which further includes communicating a sold stone event to said seller of said one stone and said inquiring prospective buyer at said corresponding offer to sell.

23. A computerized method for facilitating the sale and purchase of precious stones or diamond stones over a computer network having a plurality of computers operatively coupled together over a communications network with a computer-based data collection, said data collection storing data representing said stones including at least stone weight and at least one other stone characteristic for each said stone and including an offer to sell each said stone input by sellers and bids to buy selected stones selectively input by prospective buyers, the method comprising:
searching said data collection based upon one or more inquiries from sellers or prospective buyers and facilitating a display on an inquiring party's computer of stones which match said inquiries wherein the display data includes at least one stone, its corresponding stone weight, characteristic and offer to sell;
facilitating, as part of said display for said at least one stone, both a buy command functional display and a bid command functional display which commands are mutually exclusive;
upon activation of said buy command by an inquiring prospective buyer, communicating a sold stone event between a respective seller of said one stone and said inquiring prospective buyer at said corresponding offer to sell;
upon activation of a plurality of said bid commands by a corresponding plurality of inquiring prospective buyers for said one stone:
accepting and storing in said data collection a plurality of respective bid to buy data from said corresponding plurality of inquiring prospective buyers, each one of said plurality of bid to buy data including at least a bid price and expiry data; and,
upon activation of said plurality of said bid commands by said corresponding plurality of inquiring prospective buyers for said one stone, displaying said bid to buy data based upon predetermined primacy factors until withdrawal of said offer to sell said one stone by said respective seller or said sold stone event and displaying ast least said offer to sell and determining and displaying a ratio and a differential between said offer to sell and a highest primacy bid to buy.

24. A computerized method for facilitating the sale and purchase of precious stones or diamonds as claimed in claim 23 wherein said expiry data of said bid to buy data is either supplied by said inquiring prospective buyer or computed based upon said bid price or acceptance thereof.

25. A computerized method for facilitating the sale and purchase of precious stones or diamonds as claimed in claim 24 wherein said expiry data represents a bid validity time period and wherein said predetermined primacy factors are first based upon said bid prices in said stored bid to buy data and second based upon near term expiration of bid validity time periods.

26. A computerized method for facilitating the sale and purchase of precious stones or diamonds as claimed in claim 25 wherein:
data collection including grading lab certificate data for each of a plurality of stones therein, said grading lab certificate uniquely identifying each said stone from all other stones in said data collection;
said searching and facilitating said display of said at least one stone includes permitting electronic access to said one stone's unique lab certificate identifying said one stone from all other stones in said data collection;
said sold stone event includes permitting access to said one stone's unique lab certificate by one or both of:
a precious stones or diamonds courier having a respective computer network device coupled to said computer network, and
an independent precious stones or diamonds authentication service having a respective computer network device coupled to said computer network.

27. A computerized method for facilitating the sale and purchase of precious stones or diamonds as claimed in claim 26 wherein said sold stone event includes assessing a transaction charge on one or both of said respective seller or said respective prospective buyer, said transaction charge related to said corresponding offer to sell said one stone, said transaction charge including one or more of a shipping and handling charge for transport of said one stone and a transaction fee, and including the step of facilitating an accept bid command which further includes communicating a sold stone event to said seller of said one stone and said inquiring prospective buyer at said corresponding offer to sell.

28. A computerized method for facilitating the sale and purchase of precious stones or diamonds as claimed in claim 26 wherein the method operates on only diamond stones, said diamond stones being (a) a plurality of single diamonds; (b) a plurality of matching pairs of single diamonds; and (c) a plurality of matching sets of single diamonds;
said data collection storing data representing:
for each matching pair of said plurality of matching pairs of single diamonds, at least total stone weight data and individual stone weight data for each stone in said matching pair, and a grading certificates for each stone in said matching pair;
for each matching set of said plurality of matching sets of single diamonds, at least total stone weight data and individual stone weight data for each stone in said matching set, and a grading certificates for each stone in said matching set;
said searching and facilitating said display including permitting electronic access to said single stone unique lab certificate, said grading certificates for each stone in said matching pair, and said grading certificates for each stone in said matching set, which grading certificates uniquely identify the selected stones or stone from all other stones in said data collection.

29. A computerized method for facilitating the sale and purchase of precious stones or diamonds as claimed in claim 28 wherein said other stone characteristics include cut, color, clarity of said stones.

30. A system for facilitating the sale and purchase of precious stones or diamond stones over a computer network and a communications network, said computer network having a computer storage and retrieval facility with a data collection stored therein, said data collection storing data representing said stones including at least stone weight and at least one other stone characteristic for each said stone and a grading lab certificate uniquely identifying each said stone from all other stones in said data collection, said data collection also including an offer to sell each said stone input by sellers and including bids to buy selected stones selectively input by prospective buyers, the system comprising:
a search engine operatively coupled to said data collection and said computer network, said search engine responding to one or more inquiries by an inquiring party's computer network device and compiling search result data which match said inquiries wherein said search result data includes at least one stone, its corresponding stone weight, characteristic, electronic access link to said stone's unique lab certificate identifying said one stone from all other stones in said data collection and a corresponding offer to sell;
an output display module facilitating a display on said inquiring party's computer network device of said search result data and data of said at least one stone, its corresponding stone weight, characteristic, electronic access link to said stone's unique lab certificate, and offer a corresponding to sell;
a buy command functional display and a bid command functional display incorporated into said display for said at least one stone, said buy command and bid command functional displays operatively linked to a buy command module and a bid command module;
said buy command module upon activation of said buy command functional display, communicating a sold stone event to a respective seller of said one stone and an inquiring prospective buyer at said corresponding offer to sell and storing a representative sold stone event in said data collection for said one stone;
said bid command module upon activation of said bid command functional display, accepting and storing in said data collection a respective bid to buy data which includes at least a bid price from said inquiring prospective buyer; and,
said bid command module upon activation of said bid command functional display from either said inquiring prospective buyer or other inquiring prospective buyers, accepting further bid to buy data for said one stone therefrom and storing respective bid to buy data in said data collection;
means for disabling said buy command module and said bid command module upon accepting a withdrawal of said offer to sell said one stone by said respective seller or in the presence of said sold stone event for said one stone.

31. A system for facilitating the sale and purchase of precious stones or diamonds as claimed in claim 30 including a further display module operable with said bid command module facilitating a further display on a respective computer network device of either said inquiring prospective buyer or said other inquiring prospective buyers, said further display module facilitating said further display including said further bid to buy data for said one stone organized based upon predetermined primacy factors of said stored bid to buy data.

32. A system for facilitating the sale and purchase of precious stones or diamonds as claimed in claim 31 wherein said bid to buy data includes expiry data, either supplied by said inquiring prospective buyer or computed by a bid expiration module based upon said bid price or computed by a bid expiration module based upon acceptance of said bid price, and said expiry data represents a bid validity time period and wherein said predetermined primacy factors are first based upon said bid prices in said stored bid to buy data and second based upon near term expiration of bid validity time periods.

33. A system for facilitating the sale and purchase of precious stones or diamonds as claimed in claim 32 including a supplemental output display module:
(a) permitting access to said one stone's unique lab certificate by a precious stones or diamonds courier having a respective computer network device coupled to said computer network, and
(b) permitting access to said one stone's unique lab certificate by an independent precious stones or diamonds authentication service having a respective computer network device coupled to said computer network.

34. A system for facilitating the sale and purchase of precious stones or diamonds as claimed in claim 33 including a transaction charge module, coupled to said buy command module, said transaction charge module computing a transaction charge related to one or more of: said corresponding offer to sell said one stone, a shipping and handling charge for transport of said one stone, and a predetermined transaction fee; said transaction charge module including a transaction display sub-module facilitating said display of said transaction charge upon activation of one or both of said bid command module and said buy command module, and including an accept bid command module communicating said sold stone event to said seller of said one stone and said inquiring prospective buyer at said corresponding offer to sell.

35. A system for facilitating the sale and purchase of precious stones or diamonds as claimed in claim 34 wherein the system operates on only diamond stones, said diamond stones being (a) a plurality of single diamonds; (b) a plurality of matching pairs of single diamonds; and (c) a plurality of matching sets of single diamonds;
said data collection storing data representing:
for each matching pair of said plurality of matching pairs of single diamonds, at least total stone weight data and individual stone weight data for each stone in said matching pair, and a grading certificates for each stone in said matching pair;
for each matching set of said plurality of matching sets of single diamonds, at least total stone weight data and individual stone weight data for each stone in said matching set, and a grading certificates for each stone in said matching set;
said search engine and output display module including electronic access links to said single stone unique lab certificate, said grading certificates for each stone in said matching pair, and said grading certificates for each stone in said matching set, which grading certificates uniquely identify the selected stones or stone from all other stones in said data collection.

36. A system for facilitating the sale and purchase of precious stones or diamonds as claimed in claim 35 wherein said other stone characteristics include cut, color, clarity of said stones.

37. A system for facilitating the sale and purchase of precious stones or diamond stones over a computer network and a communications network, said computer network having a computer storage and retrieval facility with a data collection stored therein, said data collection storing data representing said stones including at least stone weight and at least one other stone characteristic for each said stone and an offer to sell each said stone input by sellers and including bids to buy selected stones selectively input by prospective buyers, the system comprising:
a search engine operatively coupled to said data collection and said computer network, said search engine responding to one or more inquiries by an inquiring party's computer network device and compiling search result data which match said inquiries wherein said search result data includes at least one stone, and a corresponding offer to sell;
an output display module facilitating a display on said inquiring party's computer network device of said search result data and data of said at least one stone, its corresponding stone weight, characteristic, and offer a corresponding to sell;
a buy command functional display and a bid command functional display incorporated into said display for said at least one stone, said buy command and bid command functional displays operatively linked to a buy command module and a bid command module;
said buy command module upon activation of said buy command functional display, communicating a sold stone event to a respective seller of said one stone and an inquiring prospective buyer at said corresponding offer to sell and storing a representative sold stone event in said data collection for said one stone;
said bid command module upon activation of said bid command functional display, accepting and storing in said data collection a respective bid to buy data which includes at least a bid price from said inquiring prospective buyer; and,
said bid command module upon activation of said bid command functional display from either said inquiring prospective buyer or other inquiring prospective buyers, accepting further bid to buy data for said one stone therefrom and storing respective bid to buy data in said data collection;
means for determining primacy factors for said further bid data and displaying said further bid data pursuant to said primacy factors as part of said output display for said at least one stone upon activation of said bid command functional display;
means for disabling said buy command module and said bid command module upon accepting a withdrawal of said offer to sell said one stone by said respective seller or in the presence of said sold stone event for said one stone.

38. A system for facilitating the sale and purchase of precious stones or diamond stones as claimed in claim 37 including an accept bid command module communicating said sold stone event to said seller of said one stone and said inquiring prospective buyer at said corresponding offer to sell.
